(19) United States
(12) Patent Application Publication
(10) Pub. No.: US 2009/0255995 A1
(43) Pub. Date: Oct. 15, 2009

(54) Semiconductor device and wireless communication system

(75) Inventors: Yutaka Shionoiri, Kanagawa (JP); Tomoaki Atsumi, Kanagawa (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi, Kanagawa-ken (JP)

(21) Appl. No.: 11/921,557

(22) PCT Filed: Jun. 21, 2006
(86) PCT No.: PCT/JP2006/312844

§ 371 Date: Dec. 5, 2007

(30) Foreign Application Priority Data
Jun. 24, 2005 (JP) 2005-185638

(51) Int. Cl. G06K 19/06

(52) U.S. Cl. 235/492

(57) ABSTRACT

Among transistors used in an analog circuit portion of the semiconductor device, particularly in a high frequency circuit, a power supply circuit, and a data demodulation circuit, and transistors used in a digital circuit portion (logic circuit portion), a gate length of a transistor in the analog circuit portion is not less than a gate length of a transistor in the digital circuit portion. As a result, when an excess voltage is supplied, voltage in the analog circuit with a long gate length is suppressed to prevent the damage of elements such as transistors in the digital circuit portion to which a signal is inputted from the analog circuit.

### TECHNICAL FIELD

The present invention relates to a semiconductor device that is capable of communicating data through wireless communication. In particular, the invention relates to a semiconductor device that only receives data, or only transmits data. The invention also relates to a wireless communication system having the semiconductor device, and a reader/writer that communicates data through wireless communication.

### BACKGROUND ART

Identification technology where an ID (identification number) is assigned to each object so as to clarify the history thereof, which is utilized for production, management, and the like has been attracting attention. Above all, RFID (Radio Frequency Identification) technology using a semiconductor device that is capable of communicating data through wireless communication, such as an RFID tag (also called an IC tag, an IC chip, an RF (Radio-Frequency) tag, a wireless tag, an electronic tag, or a transponder), has started to be employed.

A general configuration of a semiconductor device that is capable of communicating data through wireless communication is described with reference to FIG. 2.

A semiconductor device 301 that is capable of communicating data through wireless communication includes an antenna 302 and a semiconductor integrated circuit 309.

In addition, the semiconductor device 301 that is capable of communicating data through wireless communication is roughly divided into an analog circuit portion 1101 and a digital circuit portion (logic circuit portion) 1102.

The analog circuit portion 1101 includes the antenna 302, a high frequency circuit 303, a power supply circuit 304a, a limiter circuit 304b, a reset circuit 304c, a clock generation circuit 304d, a data demodulation circuit 305, a data modulation circuit 306, and the like. The digital circuit portion (logic circuit portion) 1102 includes a control circuit 307, a memory circuit 308, and the like.

Next, general operation of the semiconductor device 301 that is capable of communicating data through wireless communication is described with reference to FIG. 2.

First, a wireless signal is received by the antenna 302. The wireless signal is inputted to the power supply circuit 304a through the high frequency circuit 303, thereby generating a high power supply potential (hereinafter referred to as a VDD). The VDD is controlled by the limiter circuit 304b to be a predetermined potential or lower, and supplied to each circuit. The wireless signal is also inputted to the data demodulation circuit 305 through the high frequency circuit 303, and demodulated (hereinafter referred to as a demodulated signal). In addition, the wireless signal is inputted to the reset circuit 304c through the high frequency circuit 303. The demodulated signal is inputted to the clock generation circuit 304d. An output signal of the reset circuit 304c (hereinafter referred to as a reset), an output signal of the clock generation circuit 304d (hereinafter referred to as a clock), and the demodulated signal are inputted to the control circuit 307. The demodulated signal inputted to the control circuit 307 is analyzed by the control circuit 307. Then, in accordance with the analyzed signal, information on the semiconductor device, which is stored in the memory circuit 308, is outputted. The outputted information on the semiconductor device is encoded by the control circuit 307. Further, in accordance with the encoded information of the semiconductor device, the data modulation circuit 306 modulates a carrier wave. Thus, the information on the semiconductor device is transmitted by the antenna 302 through the wireless signal. Note that although not shown, a plurality of circuits constituting the semiconductor integrated circuit 309 are connected to a low power supply potential (hereinafter referred to as a VSS) in common. The VSS can be, for example, a GND. A potential difference between the VSS and the VDD is supplied to a plurality of circuits constituting the semiconductor integrated circuit 309 to be a power supply voltage of these circuits.

The amplitude of a wireless signal received by an antenna in a semiconductor device changes with the distance between the semiconductor device and a reader/writer that transmits and receives the wireless signal. The shorter the distance between the reader/writer and the semiconductor device is, the larger the amplitude of the wireless signal received by the antenna in the semiconductor device is. Meanwhile, the longer the distance between the reader/writer and the semiconductor device is, the smaller the amplitude of the wireless signal received by the antenna in the semiconductor device is.

When the distance between a semiconductor device and a reader/writer that transmits and receives a wireless signal is short, the VDD generated by a power supply circuit increases to supply an overvoltage (hereinafter referred to as an excess voltage) to the semiconductor device. Accordingly, elements (transistor, capacitor, resistor, and the like) in the semiconductor device may be damaged.

Thus, the semiconductor device includes the limiter circuit 304b as shown in FIG. 2, so that a high power supply potential higher than a predetermined potential is not supplied to the internal circuit. A semiconductor device using such a limiter circuit is disclosed in, for example, Patent Document 1. Note that a limiter circuit is referred to as a regulator circuit in Patent Document 1.

[Patent Document 1] Japanese Patent Laid-Open. No. 2001-125653

### DISCLOSURE OF INVENTION

A conventional semiconductor device including a limiter circuit has problems that the circuit configuration in the semiconductor device is complicated and the size of the semiconductor device increases.

In view of the foregoing problems, the invention provides a semiconductor device that is capable of communicating data through wireless communication wherein a simple circuit configuration and a small size are achieved, and elements (transistor, capacitor, resistor, and the like) in the semiconductor device are prevented from being damaged due to an excess voltage.

The invention has the following features in order to solve the foregoing problems.

A semiconductor device of the invention includes an analog circuit portion and a digital circuit portion (logic circuit portion). Among transistors used in the analog circuit portion and the digital circuit portion (logic circuit portion) in the semiconductor device, the gate length (channel length) of a transistor in the analog circuit portion, particularly in a power supply circuit and a data demodulation circuit, is not less than the gate length (channel length) of a transistor in the digital circuit portion (logic circuit portion).

The gate length (channel length) of a transistor used in the analog circuit portion, particularly in the power supply circuit and the data demodulation circuit is preferably not less than twice the gate length (channel length) of a transistor used in the digital circuit portion (logic circuit portion).

A semiconductor device of the invention includes an analog circuit portion to which a wireless signal is inputted. The analog circuit portion includes a power supply circuit for generating a DC voltage using a wireless signal, a data demodulation circuit for demodulating a wireless signal, and a clock generation circuit for generating a clock using an output of the data demodulation circuit. The gate length (channel length) of a transistor included in the power supply circuit and the data demodulation circuit is not less than the gate length (channel length) of a transistor included in the clock generation circuit.

The gate length (channel length) of a transistor used in the power supply circuit and the data demodulation circuit is preferably not less than twice the gate length (channel length) of a transistor used in the clock generation circuit.

Note that in the case of a multi-gate transistor (in which a plurality of transistors are connected in series), the gate length (channel length) of the multi-gate transistor means the gate length (channel length) of each of a plurality of transistors constituting the multi-gate transistor.

In the invention, a transistor including a gate electrode that has two or more different gate lengths may be used for different widths of the gate electrode. In this case, the shortest length of different gate lengths in a gate electrode of a transistor in an analog circuit has only to be longer than the longest length of different gate lengths of a gate electrode of a transistor in a digital circuit.

When the gate length of a transistor in the analog circuit portion, particularly in the power supply circuit and the data demodulation circuit, is not less than the gate length of a transistor in the digital circuit portion (logic circuit portion), voltage in the analog circuit portion with a long gate length can be suppressed without a specific circuit such as a limiter circuit if an excess voltage is supplied. In addition, in the digital circuit portion (logic circuit portion) to which a signal is inputted from the analog circuit portion, elements in the circuit such as transistors can be prevented from being damaged.

The analog circuit portion, particularly the power supply circuit and the data demodulation circuit generate a constant potential (VDD) from a received wireless signal, or generate a demodulated signal having a lower frequency than the received wireless signal. That is to say, the analog circuit portion, particularly the power supply circuit and the data demodulation circuit are mainly intended to process the received wireless signal, and thus are not required to operate at a high frequency. On the other hand, the digital circuit portion (logic circuit portion), and the clock generation circuit and the like in the analog circuit portion are required to operate at a high frequency in order to perform arithmetic processing and the like using the demodulated signal, the VDD, and the like generated in the analog circuit portion. Accordingly, among the transistors used in the analog circuit portion and the digital circuit portion (logic circuit portion) in the semiconductor device, the gate length of a transistor in the analog circuit portion, particularly in the power supply circuit and the data demodulation circuit is not less than the gate length of a transistor in the digital circuit portion (logic circuit portion). Thus, economical operation that is suitable for the intended purpose of each circuit can be achieved.

### BRIEF DESCRIPTION OF DRAWINGS

FIG. 1 shows a configuration of a semiconductor device of the invention.

FIG. 2 shows a configuration of a conventional semiconductor device.

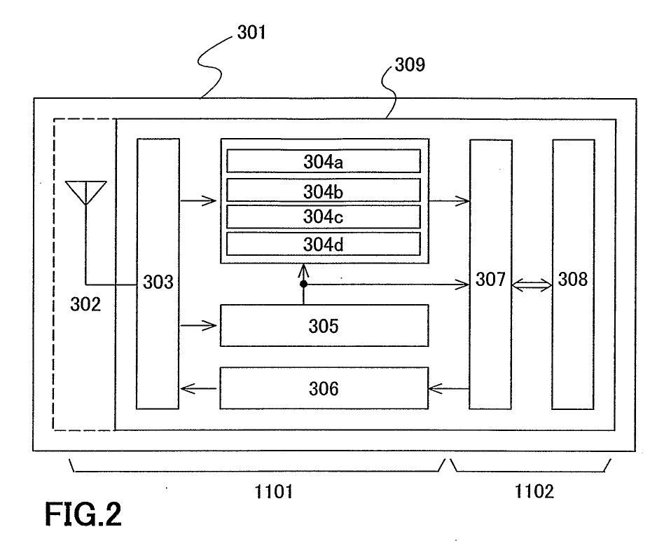

FIG. 3 shows a configuration of a semiconductor device of the invention.

FIGS. 4A and 4B each show a part of a mask layout of a semiconductor device of the invention.

FIGS. 5A to 5D each show a configuration of an antenna in a semiconductor device of the invention.

FIGS. 6A to 6D each show a method for manufacturing a semiconductor device of the invention.

FIGS. 7A and 7B each show a method for leading a wiring of a semiconductor device.

FIGS. 8A to 8C each show a method for manufacturing a semiconductor device of the invention.

FIGS. 9A and 9B each show an application of a semiconductor device of the invention.

FIGS. 10A to 10E each show an application of a semiconductor device of the invention.

FIG. 11 shows a method for manufacturing a semiconductor device of the invention.

FIGS. 12A to 12E each show a method for manufacturing a semiconductor device of the invention.

FIGS. 13A and 13B each show a method for manufacturing a semiconductor device of the invention.

FIGS. 14A and 14B each show a method for manufacturing a semiconductor device of the invention.

FIGS. 15A and 15B each show a method for manufacturing a semiconductor device of the invention.

FIGS. 16A and 16B respectively show a part of a mask layout of a semiconductor device of the invention, and an equivalent circuit.

FIGS. 17A and 17B each show a configuration of a semiconductor device of the invention.

FIGS. 18A to 18C each show a configuration of an antenna in a semiconductor device of the invention.

### BEST MODE FOR CARRYING OUT THE INVENTION

Although the invention will be described by way of embodiment mode and embodiments with reference to the accompanying drawings, it is to be understood that various changes and modifications will be apparent to those skilled in the art. Therefore, unless such changes and modifications depart from the scope of the invention, they should be construed as being included therein. Note that in the following description of the invention, the identical portions are denoted by the identical reference numerals in different drawings.

In the invention, connection between elements means electrical connection. Therefore, another element and the like may be provided between the elements.

### Embodiment Mode 1

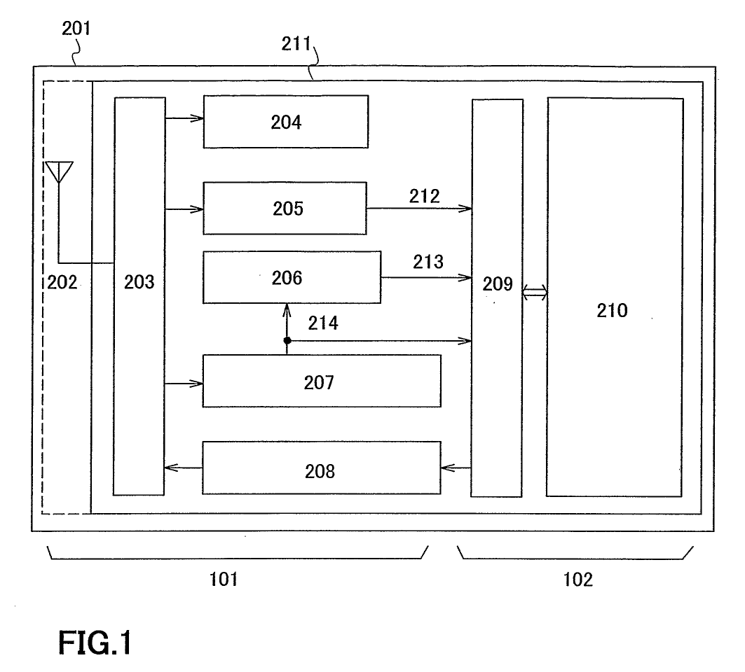

In Embodiment Mode 1, a configuration of a semiconductor device of the invention that is capable of communicating data through wireless communication and operation of the semiconductor device are described with reference to FIG. 1.

First, a configuration of a semiconductor device of the invention that is capable of communicating data through wireless communication is described. A semiconductor device 201 mainly includes an analog circuit portion 101 and a digital circuit portion (logic circuit portion) 102. The analog circuit portion 101 includes an antenna 202, a high frequency circuit 203, a power supply circuit 204, a reset circuit 205, a clock generation circuit 206, a data demodulation circuit 207, a data modulation circuit 208, and the like. The digital circuit portion (logic circuit portion) 102 includes a control circuit 209, a memory circuit 210, and the like.

Next, operation of the semiconductor device of the invention that is capable of communicating data through wireless communication is described. A wireless signal is received by the antenna 202. The wireless signal is inputted to the power supply circuit 204 through the high frequency circuit 203, thereby generating a high power supply potential (hereinafter referred to as a VDD). Although not shown, the VDD is supplied to each circuit included in a semiconductor integrated circuit 211. A signal inputted to the data demodulation circuit 207 through the high frequency circuit 203 is demodulated (hereinafter referred to as a demodulated signal 214). The wireless signal is also inputted to the reset circuit 205 through the high frequency circuit 203, and an output signal (reset 212) of the reset circuit 205 is inputted to the control circuit 209. The demodulated signal 214 is inputted to the clock generation circuit 206, and an output signal (clock 213) of the clock generation circuit 206 is inputted to the control circuit 209. In addition, the demodulated signal 214 is inputted to the control circuit 209. The signal inputted to the control circuit 209 is analyzed by the control circuit 209. Then, in accordance with the analyzed signal, information on the semiconductor device, which is stored in the memory circuit 210, is outputted. The outputted information on the semiconductor device is encoded by the control circuit 209. Further, in accordance with the encoded information on the semiconductor device, the data demodulation circuit 208 demodulates a carrier wave. Thus, the information on the semiconductor device is transmitted by the antenna 202 through a wireless signal. Note that although not shown, a plurality of circuits included in the semiconductor integrated circuit 211 are connected to a low power supply potential (hereinafter referred to as a VSS) in common. The VSS can be, for example, a GND (ground potential).

The gate length of a transistor used in the analog circuit portion 101, particularly in the power supply circuit 204 and the data demodulation circuit 207 is not less than the gate length of a transistor used in the digital circuit portion (logic circuit portion) 102 including the control circuit 209, the memory circuit 210, and the like.

As a result, when an excess voltage is supplied, voltage in the analog circuit portion having a long gate length can be suppressed without a specific circuit such as a limiter circuit. Further, in the digital circuit portion (logic circuit portion) 102 to which a signal is inputted from the analog circuit portion 101, elements in the circuit such as transistors can be prevented from being damaged.

The analog circuit portion 101, particularly the power supply circuit 204 and the data demodulation circuit 207 generate a constant potential (VDD) from a received wireless signal, or generate a demodulated signal having a lower frequency than the received wireless signal. That is to say, the analog circuit portion 101, particularly the power supply circuit 204 and the data demodulation circuit 207 are mainly intended to process a received wireless signal, and thus are not required to operate at a high frequency. On the other hand, the digital circuit portion (logic circuit portion) 102, and the clock generation circuit 206 and the like in the analog circuit portion 101 are required to operate at a high frequency in order to perform arithmetic processing and the like using a demodulated signal, a VDD, and the like generated in the analog circuit portion 101. Accordingly, among the transistors used in the analog circuit portion 101 and the digital circuit portion (logic circuit portion) 102 in the semiconductor device, the gate length of a transistor in the analog circuit portion 101, particularly in the power supply circuit 204 and the data demodulation circuit 207 is not less than the gate length of a transistor in the digital circuit portion (logic circuit portion) 102. Thus, economical operation that is suitable for the intended purpose of each circuit can be achieved.

A wireless signal received by the antenna 202 in the semiconductor device of the invention is a signal that is obtained by modulating a carrier wave. A carrier wave is modulated by analog modulation or digital modulation, for which any of amplitude modulation, phase modulation, frequency modulation, and spread spectrum may be employed.

The frequency of a carrier wave may be any of 300 GHz to 3 THz as a submillimeter wave, not less than 30 GHz and less than 300 GHz as a millimeter wave, not less than 3 GHz and less than 30 GHz as a microwave, not less than 300 MHz and less than 3 GHz as an ultrashort wave, not less than 30 MHz and less than 300 MHz as a very short wave, not less than 3 MHz and less than 30 MHz as a short wave, not less than 300 KHz and less than 3 MHz as a medium wave, not less than 30 KHz and less than 300 KHz as a long wave, and not less than 3 KHz and less than 30 KHz as a very long wave. It is desirable that the frequency of a carrier wave be not less than 1 GHz.

A potential difference between the VSS and the VDD generated by the power supply circuit 204, namely a power supply voltage (operating voltage) of the semiconductor device of the invention may be 1 to 6 V, and desirably not less than 3 V. The power supply voltage of the semiconductor device of the invention can be the same in the analog circuit portion 101 and the digital circuit portion (logic circuit portion) 102.

The memory circuit 210 can be formed using a DRAM (Dynamic Random Access Memory), an SRAM (Static Random Access Memory), an FeRAM (Ferroelectric Random Access Memory), a mask ROM (Read Only Memory), an EPROM (Electrically Programmable Read Only Memory), an EEPROM (Electrically Erasable and Programmable Read Only Memory), or a flash memory.

According to the aforementioned configuration, the semiconductor device of the invention that is capable of communicating data through wireless communication can prevent elements in the circuits from being damaged without a limiter circuit. Thus, a semiconductor device with a reduced size and high reliability can be provided.

### Embodiment Mode 2

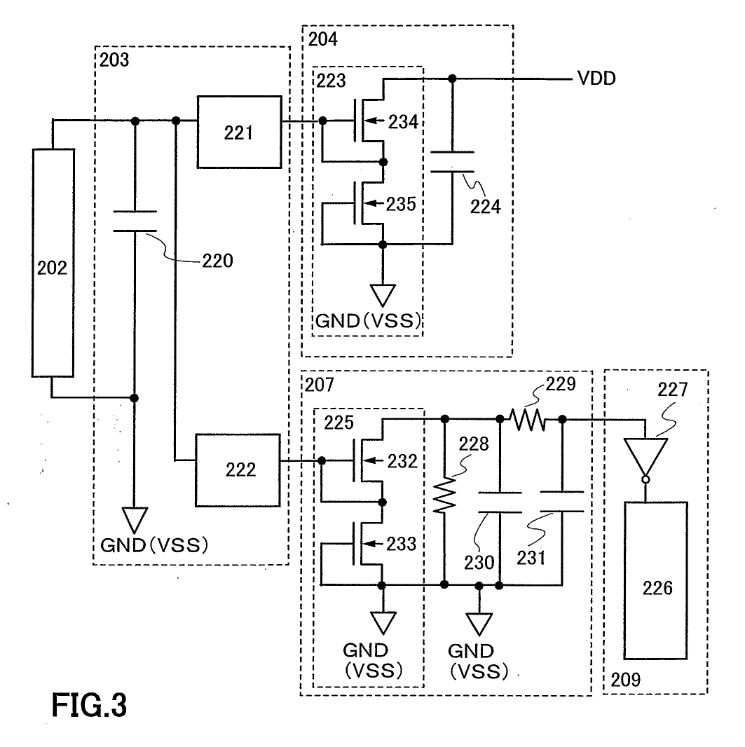

In Embodiment Mode 2, operation is described with reference to FIG. 3 that shows a part of an actually designed circuit. Note that FIG. 3 shows only a minimum circuit configuration necessary for describing the operation, and other parts that are not shown in the drawing are similar to those in FIG. 1.

The high frequency circuit 203 includes a resonant capacitor 220, a first band-pass filter 221, and a second band-pass filter 222. The resonant capacitor 220 is provided in order that a signal with a frequency that is to be received by the antenna 202 is received in the most efficient manner. The first band-pass filter 221 and the second band-bass filter 222 are provided to remove noise. The first band-pass filter 221 and the second band-pass filter 222 may be combined into one band-pass filter, though the two band-pass filters are desirably provided.

The first band-pass filter 221 and the second band-pass filter 222 that are provided to remove noise are mainly formed by the connection of a resistor and a capacitor. The resistor and the capacitor are connected in different manners between the case of blocking high frequency noise and the case of blocking low frequency noise. For example, in order to remove low frequency noise, the capacitor and the resistor may be connected in series to form a high-pass filter. The bandwidth of noise to be removed is determined by design specifications suitable for the intended purpose of the semiconductor device of the invention. Either or both the capacitance of the capacitor and the resistance of the resistor are desirably large in order to completely block a frequency to be blocked. Note that although each of the aforementioned band-pass filters is formed by the connection of the resistor and the capacitor, a transistor may be used instead of the resistor and the capacitor, and other configurations may be employed as long as a frequency to be blocked can be blocked. Further, instead of the resistor and the capacitor, or in addition to the resistor and the capacitor, parasitic capacitance of a wiring, an electrode, or the like, or parasitic capacitance due to overlapping wirings or overlapping electrodes may be actively utilized.

A wireless signal (AC signal) passing through the first band-pass filter 221 is inputted to the power supply circuit 204. Then, the inputted wireless signal (AC signal) is rectified by a first rectification circuit 223 in the power supply circuit 204. Further, the rectified signal is smoothed by a storage capacitor 224, thereby generating a high power supply potential (VDD). The VDD is supplied to a plurality of circuit blocks in the semiconductor device of the invention.

The first rectification circuit 223 includes two N-channel transistors. A gate and a source of an N-channel transistor 234 are connected to each other, and the VDD is supplied to a drain thereof. The VSS (GND) is supplied to a gate and a source of an N-channel transistor 235, and a drain thereof is connected to the gate and the source of the N-channel transistor 234. In this manner, a received wireless signal can be rectified.

Note that the first rectification circuit 223 is not limited to the circuit configuration shown in FIG. 3, and other circuit configurations different from that shown in FIG. 3 may also be used as long as an AC signal can be converted into a DC signal. For example, a half-wave rectification circuit, a full-wave rectification circuit, or the like can be used.

A wireless signal (AC signal) passing through the second band-pass filter 222 is inputted to the data demodulation circuit 207. Then, the inputted wireless signal (AC signal) is rectified by a second rectification circuit 225 in the data demodulation circuit 207. Further, the rectified signal is demodulated by a first resistor 228, a first capacitor 230, a second resistor 229, and a second capacitor 231 (hereinafter referred to as a demodulated signal). The demodulated signal is inputted to a plurality of circuit blocks in the semiconductor device 201.

The second rectification circuit 225 includes two N-channel transistors. A gate and a source of an N-channel transistor 232 are connected to each other, and a drain thereof is connected to one end of the first resistor 228, one end of the first capacitor 230, and one end of the second resistor 229. The VSS (GND) is supplied to a gate and a source of an N-channel transistor 233, and a drain thereof is connected to the gate and the source of the N-channel transistor 232.

The VSS (GND) is supplied to the other end of the first resistor 228 and the other end of the first capacitor 230. Further, the other end of the second resistor 229 is connected to one end of the second capacitor 231, and the VSS (GND) is supplied to the other end of the second capacitor 231. The other end of the second resistor 229 and one end of the second capacitor 231 correspond to an output of the data demodulation circuit 207.

In this manner, the received AC signal can be rectified and demodulated by the data demodulation circuit 207.

Note that the second rectification circuit 225 is not limited to the circuit configuration shown in FIG. 3, and other circuit configurations different from that shown in FIG. 3 may also be used as long as an AC signal can be converted into a DC signal. For example, a half-wave rectification circuit, a full-wave rectification circuit, or the like can be used.

The connection and configuration of the plurality of resistors and capacitors for demodulating a signal that has been converted into a DC signal by the second rectification circuit 225 are not limited to those shown in FIG. 3. A transistor may be used additionally to the resistors and the capacitors, and any circuit configuration may be employed as long as a signal converted into a DC signal can be demodulated.

FIG. 3 shows an example where the thus outputted demodulated signal is inputted to the control circuit 209. Although FIG. 3 shows an example where the demodulated signal is inputted to an inverter 227 in the control circuit 229, the circuit to which the demodulated signal is inputted is not limited to the configuration shown in FIG. 3 since the circuit can be varied depending on the design. The inverter may be used-as described above, or other logic circuits, elements such as a capacitor, a resistor, and an inductance, or a combination thereof may be used. Note that instead of the resistors and the capacitors, or in addition to the resistors and the capacitors, parasitic capacitance of a wiring, an electrode, or the like, or parasitic capacitance due to overlapping wirings or overlapping electrodes may be actively utilized.

In this manner, an output signal that is obtained from a demodulated signal inputted to the inverter 227 in the control circuit 209 is inputted to a circuit in control circuit 226.

The circuit in control circuit 226 is designed in accordance with design specifications suitable for the intended purpose of the semiconductor device of the invention.

In FIG. 3, the antenna 202, the high frequency circuit 203, the power supply circuit 204, and the data demodulation circuit 207 correspond to the analog circuit portion. Transistors are used in the first rectification circuit 223 in the power supply circuit 204 and the second rectification circuit 225 in the data demodulation circuit 207.

Meanwhile, the control circuit 209 corresponds to the digital circuit portion (logic circuit portion). The inverter 227 in the control circuit 209 can be given as an example of a transistor used in the control circuit 209.

In Embodiment Mode 2, the N-channel transistor 234 and the N-channel transistor 235 that are used in the first rectification circuit 223 in the power supply circuit 204 corresponding to the analog circuit portion, and the N-channel transistor 232 and the N-channel transistor 233 that are used in the second rectification circuit 225 in the data demodulation circuit 207 corresponding to the analog circuit portion each are designed so as to have a gate length of 3.3 μm. A transistor used for the inverter 227 in the control circuit 209 corresponding to the digital circuit portion (logic circuit portion) is designed so as to have a gate length of 1.3 μm. In addition, transistors used in the circuit in control circuit 226, and the memory circuit 210 and the like (not shown) each can be designed so as to have a gate length of 1.3 μm.

The gate length of the transistor used in the analog circuit portion, particularly in the power supply circuit 204 and the data demodulation circuit 207 is not less than the gate length of the transistor used in the digital circuit portion (logic circuit portion) including the control circuit 209, the memory circuit 210, and the like. The gate length of the transistor used in the analog circuit portion, particularly in the power supply circuit 204 and the data demodulation circuit 207 is preferably not less than twice the gate length of the transistor used in the digital circuit portion (logic circuit portion) including the control circuit 209, the memory circuit 210, and the like.

As a result, when an excess voltage is supplied, voltage in the analog circuit portion having a long gate length can be suppressed without a specific circuit such as a limiter circuit. Further, in the digital circuit portion (logic circuit portion) to which a signal is inputted from the analog circuit portion, elements in the circuit such as transistors can be prevented from being damaged.

The analog circuit portion, particularly the power supply circuit 204 and the data demodulation circuit 207 generate a high power supply potential (VDD) from a received wireless signal, or generate a demodulated signal having a lower frequency than the received wireless signal. That is to say, the analog circuit portion, particularly the power supply circuit 204 and the data demodulation circuit 207 are mainly intended to process a received wireless signal, and thus are not required to operate at a high frequency. On the other hand, the digital circuit portion (logic circuit portion), and the clock generation circuit 206 and the like in the analog circuit portion are required to operate at a high frequency in order to perform arithmetic processing and the like using a demodulated signal, the VDD, and the like generated in the analog circuit portion. Accordingly, among the transistors used in the analog circuit portion and the digital circuit portion (logic circuit portion) in the semiconductor device, the gate length of a transistor in the analog circuit portion, particularly in the power supply circuit 204 and the data demodulation circuit 207 is not less than the gate length of a transistor in the digital circuit portion (logic circuit portion). Thus, economical operation that is suitable for the intended purpose of each circuit can be achieved.

According to the aforementioned configuration, the semiconductor device of the invention that is capable of communicating data through wireless communication can prevent elements in the circuits from being damaged without a limiter circuit. Thus, a semiconductor device with a reduced size and high reliability can be provided.

This embodiment mode can be freely implemented in combination with Embodiment Mode 1.

### Embodiment Mode 3

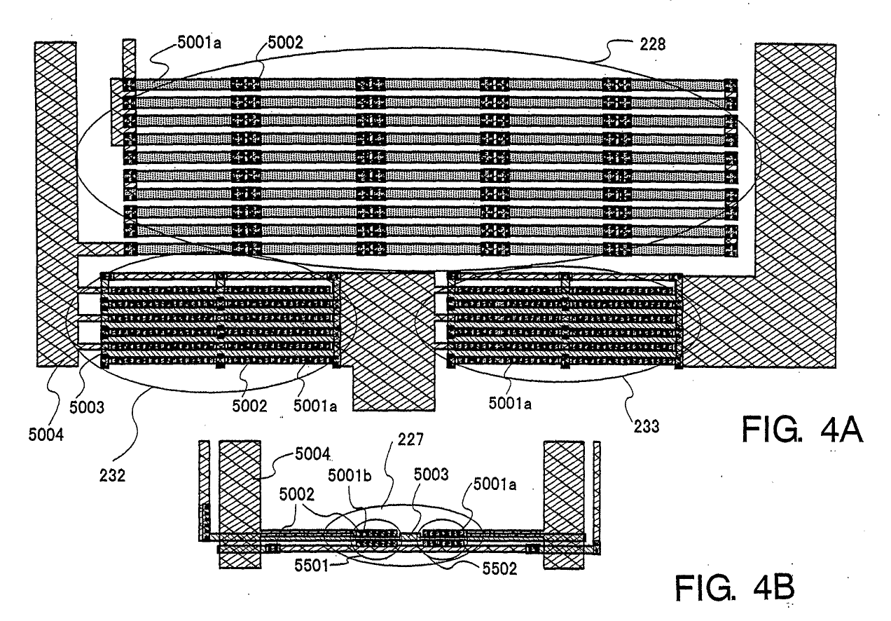

In Embodiment Mode 3, a mask layout that is a part of the circuit of the semiconductor device of the invention shown in FIG. 3 is described with reference to FIGS. 4A and 4B. In FIGS. 4A and 4B, reference numeral 5001a denotes an N-type semiconductor layer, 5001b denotes a P-type semiconductor layer, 5003 denotes a first wiring, 5004 denotes a second wiring, and 5002 denotes a contact hole.

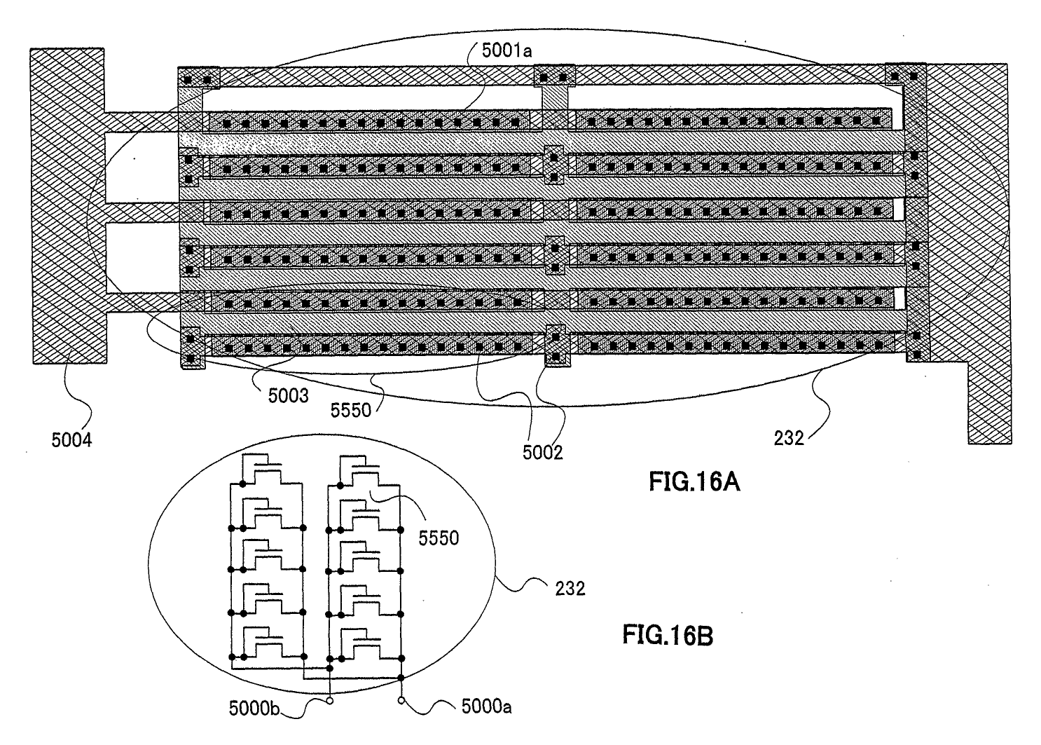

FIG. 4A shows the second rectification circuit 225 and the first resistor 228 used in the data demodulation circuit 207 in FIG. 3. Each of the N-channel transistor 232 and the N-channel transistor 233 in the second rectification circuit 225 is constituted by the N-type semiconductor layer 5001a, an insulating film that is in contact with the N-type semiconductor layer 5001a, and the first wiring 5003 that overlaps the N-type semiconductor layer 5001a with the insulating film interposed therebetween. In the N-channel transistor 232 and the N-channel transistor 233, the first wiring 5003 functions as a gate electrode and the insulating film functions as a gate insulating film. In FIG. 4A, each of the N-channel transistor 232 and the N-channel transistor 233 includes two pairs of five diode-connected transistors (in which a gate and a drain are connected to each other), and the two pairs of transistors are connected in parallel. In other words, 10 diode-connected transistors are connected in parallel. FIGS. 16A and 16B show an enlarged view of the N-channel transistor 232 and an equivalent circuit thereof, respectively. The N-channel transistor 232 has a structure where 10 N-channel transistors 5550 are connected in parallel between a terminal 5000a and a terminal 5000b. When the N-channel transistor 232 is constituted by the plurality of N-channel transistors 5550 connected in parallel, the channel width of the N-channel transistor 232 can be increased and high degree of freedom of the layout thereof can be achieved. Although the N-channel transistor 232 is shown as an example in FIGS. 16A and 16B, the same applies to the N-channel transistor 233. Thus, an area occupied by the second rectification circuit 225 including the N-channel transistor 232 and the N-channel transistor 233 can be reduced.

Although the second rectification circuit 225 is shown as an example in FIGS. 4A and 4B and FIGS. 16A and 16B, a similar structure can be applied to the first rectification circuit 223 included in the power supply circuit 204.

The first resistor 228 is constituted by the plurality of N-type semiconductor layers 5001a that are processed into island shapes, and the second wiring 5004 for connecting the plurality of N-type semiconductor layers 5001a. The plurality of N-type semiconductor layers 5001a and the second wiring 5004 are connected to each other through the contact hole 5002.

FIG. 4B shows the inverter 227 in the control circuit in FIG. 3. The inverter 227 in the control circuit is constituted by a P-channel transistor 5501 and an N-channel transistor 5502. The P-channel transistor 5501 is constituted by the P-type semiconductor layer 5001b, an insulating film that is in contact with the P-type semiconductor layer 5001b, and the first wiring 5003 that overlaps the P-type semiconductor layer 5001b with the insulating film interposed therebetween. In the P-channel transistor 5501, the first wiring 5003 functions as a gate electrode and the insulating film functions as a gate insulating film. The N-channel transistor 5502 is constituted by the N-type semiconductor layer 5001a, an insulating film that is in contact with the N-type semiconductor layer 5001a, and the first wiring 5003 that overlaps the N-type semiconductor layer 5001a with the insulating film interposed therebetween. In the N-channel transistor 5502, the first wiring 5003 functions as a gate electrode and the insulating film functions as a gate insulating film.

The N-channel transistor 232 and the N-channel transistor 233 that are used in the second rectification circuit 225 corresponding to a part of the analog circuit portion each are designed so as to have a gate length of 3.3 μm. A transistor used for the inverter 227 in the control circuit 209 corresponding to the digital circuit portion (logic circuit portion) is designed so as to have a gate length of 1.3 μm.

That is to say, the gate length of the transistor used in the data demodulation circuit 207 corresponding to the analog circuit portion is not less than the gate length of the transistor used in the digital circuit portion (logic circuit portion).

As a result, when an excess voltage is supplied, voltage in the analog circuit portion having a long gate length can be suppressed without a specific circuit such as a limiter circuit. Further, in the digital circuit portion (logic circuit portion) to which a signal is inputted from the analog circuit portion, elements in the circuit such as transistors can be prevented from being damaged.

The data demodulation circuit 207 corresponding to the analog circuit portion generates a demodulated signal having a lower frequency than a wireless signal (a received wireless signal), and thus is not required to operate at a high frequency. On the other hand, the inverter 227 in the control circuit corresponding to the digital circuit portion (logic circuit portion) is required to operate at a high frequency in order to perform arithmetic processing and the like using a demodulated signal, the VDD, and the like generated in the analog circuit portion. Accordingly, among the transistors used in the analog circuit portion and the digital circuit portion (logic circuit portion) in the semiconductor device, the gate length of a transistor in the analog circuit portion is not less than the gate length of a transistor in the digital circuit portion (logic circuit portion). Thus, economical operation that is suitable for the intended purpose of each circuit can be achieved.

According to the aforementioned configuration, the semiconductor device of the invention that is capable of communicating data through wireless communication can prevent elements in the circuits from being damaged without a limiter circuit. Thus, a semiconductor device with a reduced size and high reliability can be provided.

This embodiment mode can be freely implemented in combination with any of Embodiment Modes 1 and 2.

### Embodiment 1

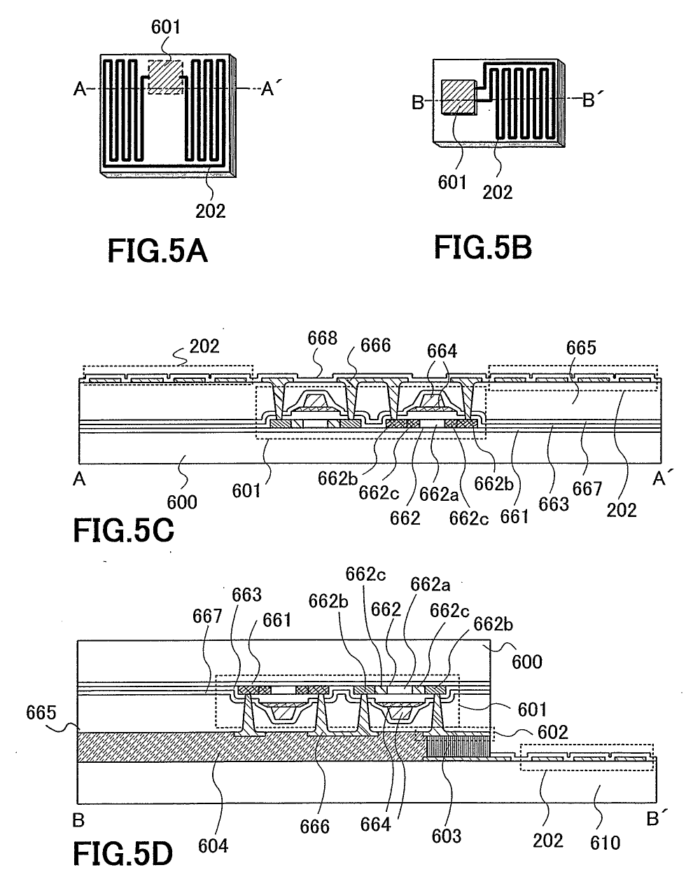

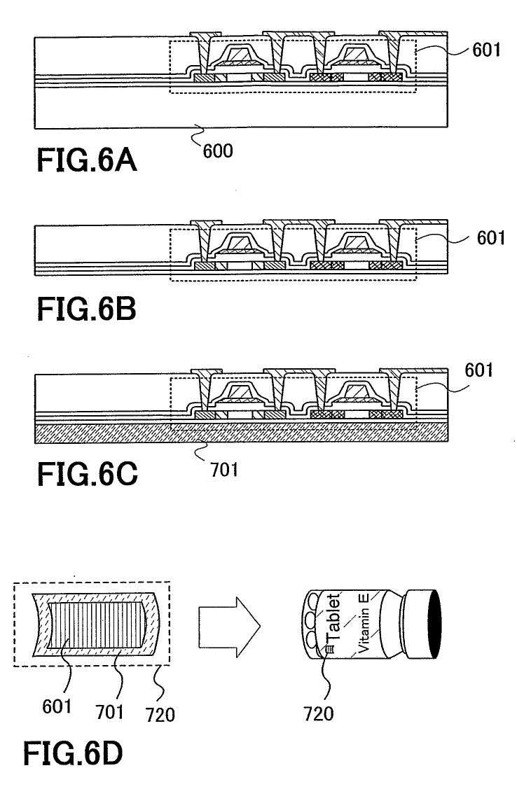

In this embodiment, a configuration of the semiconductor device of the invention is specifically described with reference to FIGS. 5A to 6D.

FIGS. 5A to 5D show an example of a structure of the antenna 202 in the semiconductor device 201 of the invention shown in FIG. 1 and FIG. 3. The antenna 202 is provided in two ways, one of which (hereinafter referred to as a first antenna installation system) is shown in FIGS. 5A and 5C and the other (hereinafter referred to as a second antenna installation system) is shown in FIGS. 5B and 5D. FIG. 5C is a cross sectional view along a line A-A′ of FIG. 5A, while FIG. 5D is a cross sectional view along a line B-B′ of FIG. 5B.

According to the first antenna installation system, the antenna 202 is provided over a substrate 600 over which a plurality of elements (hereinafter referred to as an element group 601) are provided (see FIGS. 5A and 5C). The element group 601 constitutes circuits other than the antenna in the semiconductor device of the invention. The element group 601 includes a plurality of thin film transistors. In the shown structure, a conductive film functioning as the antenna 202 is provided over the same layer as a wiring that is connected to a source or a drain of a thin film transistor included in the element group 601. However, the conductive film functioning as the antenna 202 may be provided over the same layer as a gate electrode 664 of the thin film transistor included in the element group 601, or provided over an insulating film that is formed to cover the element group 601.

According to the second antenna installation system, a terminal portion 602 is provided over the substrate 600 over which the element group 601 is provided. Then, the terminal portion 602 is connected to the antenna 202 that is formed over a substrate 610 that is different from the substrate 600 (see FIGS. 5B and 5D). In the shown structure, a part of a wiring connected to a source or a drain of a thin film transistor included in the element group 601 is used as the terminal portion 602. Then, the substrate 600 is attached to the substrate 610 so that the antenna 202 is connected to the terminal portion 602. A conductive particle 603 and a resin 604 are provided between the substrate 600 and the substrate 610. The antenna 202 is electrically connected to the terminal portion 602 with the conductive particle 603.

The structure and manufacturing method of the element group 601 are described. When a plurality of element groups 601 are formed over a large substrate and cut off to be completed, an inexpensive element group can be provided. As the substrate 600, for example, a glass substrate made of barium borosilicate glass, alumino borosilicate glass, or the like, a quartz substrate, a ceramic substrate, or the like can be used. Alternatively, a semiconductor substrate having a surface provided with an insulating film may be used. A substrate made of a flexible synthetic resin such as plastic may also be used. The surface of the substrate may be planarized by polishing such as CMP (Chemical Mechanical Polishing). A substrate that is thinned by polishing a glass substrate, a quartz substrate, or a semiconductor substrate may be used as well.

As a base layer 661 formed over the substrate 600, an insulating film made of silicon oxide, silicon nitride, silicon nitride oxide, or the like can be used. The base layer 661 can prevent alkali metal or alkaline earth metal contained in the substrate 600, such as Na, from being diffused in the semiconductor layer 662 and adversely affecting the characteristics of the thin film transistor. Although the base layer 661 shown in FIG. 5 has a single layer structure, it may have a two or more layer structure. Note that if the diffusion of impurities is not a serious problem such as in a quartz substrate, the base layer 661 is not necessarily provided.

Note that the surface of the substrate 600 may be directly processed by high density plasma. The high density plasma is generated using a high frequency wave (for example, 2.45 GHz). High density plasma with an electron density of 10¹¹ to 10¹³/cm³, an electron temperature of 2 eV or lower, and an ion energy of 5 eV or lower is used. Such high density plasma that features a low electron temperature has low kinetic energy of active species; therefore, a film with less plasma damage and defects can be formed as compared to that formed by conventional plasma treatment. Plasma can be generated using a plasma processing apparatus utilizing high frequency excitation, which employs a radial slot antenna. The distance between the antenna that generates a high frequency wave and the substrate 600 is 20 to 80 mm (preferably, 20 to 60 mm).

The surface of the substrate 600 can be nitrided by performing the high density plasma treatment in a nitrogen atmosphere, for example an atmosphere containing nitrogen (N) and rare gas (containing at least one of He, Ne, Ar, Kr, and Xe), an atmosphere containing nitrogen, hydrogen (H), and rare gas, or an atmosphere containing ammonium (NH₃) and rare gas. If the substrate 600 is made of glass, quartz, a silicon wafer, or the like, a nitride layer formed over the surface of the substrate 600, which contains silicon nitride as a main component, can be used as a blocking layer against impurities diffused from the substrate 600 side. A silicon oxide film or a silicon oxynitride film may be formed over the nitride layer by plasma CVD to be used as the base layer 661.

When similar high density plasma treatment is applied to the surface of the base layer 661 made of silicon oxide, silicon oxynitride, or the like, the surface and a region with a depth of 1 to 10 nm from the surface can be nitrided. This extremely thin silicon nitride layer is favorable since it functions as a blocking layer and has less stress on the semiconductor layer 662 formed thereover.

A crystalline semiconductor film or an amorphous semiconductor film that is processed into a predetermined shape can be used as the semiconductor layer 662. Alternatively, an organic semiconductor film may be used. A crystalline semiconductor film can be obtained by crystallizing an amorphous semiconductor film. A laser crystallization method, a thermal crystallization method using RTA or an annealing furnace, a thermal crystallization method using a metal element which promotes crystallization, or the like can be used as the crystallization method. The semiconductor layer 662 includes a channel forming region 662a and a pair of impurity regions 662b to which an impurity element imparting conductivity is added. Shown here is a structure where low concentration impurity regions 662c to which the impurity element is added at a lower concentration than to the impurity regions 662b are provided between the channel forming region 662a and the pair of impurity regions 662b; however, the invention is not limited to this. The low concentration impurity regions 662c are not necessarily provided.

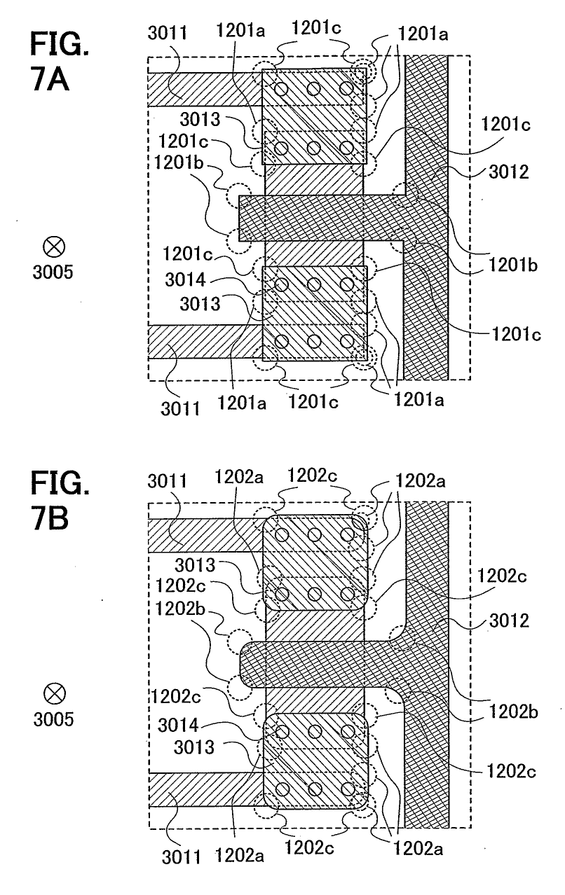

Note that a wiring that is formed simultaneously with the semiconductor layer 662 is preferably led so that corners are rounded when seen from a direction 3005 perpendicular to the top surface of the substrate 600. FIGS. 7A and 7B are schematic views each showing the method for leading wirings. In FIGS. 7A and 7B, a wiring 3011 is formed simultaneously with the semiconductor layer. FIG. 7A shows a conventional method for leading wirings. FIG. 7B shows a method for leading wirings of the invention. Corners 1202a of the wiring 3011 of the invention are rounded as compared to corners 1201a of the conventional wiring 3011. The rounded corners can prevent dusts and the like from remaining at the corners of the wiring. As a result, defects of a semiconductor device caused by dusts can be reduced and the yield can be improved.

An impurity element that imparts conductivity may be added to the channel forming region 662a of the thin film transistor. In this manner, a threshold voltage of the thin film transistor can be controlled.

A first insulating layer 663 can be formed using a single layer or a stack of a plurality of layers made of silicon oxide, silicon nitride, silicon nitride oxide, or the like. In this case, the surface of the first insulating layer 663 may be processed by high density plasma in an oxygen atmosphere or a nitrogen atmosphere, thereby being oxidized or nitrided to be densified. The high density plasma is generated using a high frequency (for example, 2.45 GHz) as described above. Note that high density plasma with an electron density of 10¹¹ to 10¹³/cm³, an electron temperature of 2 eV or lower, and an ion energy of 5 eV or lower is used. Plasma can be generated using a plasma processing apparatus utilizing high frequency excitation, which employs a radial slot antenna. In the apparatus for generating high density plasma, the distance between the antenna that generates a high frequency wave and the substrate 600 is 20 to 80 mm (preferably, 20 to 60 mm).

Before forming the first insulating layer 663, the high density plasma treatment may be applied to the surface of the semiconductor layer 662 so that the surface of the semiconductor layer 662 is oxidized or nitrided. At this time, by performing the treatment in an oxygen atmosphere or a nitrogen atmosphere with the substrate 600 at a temperature of 300 to 450° C., a favorable interface can be formed with the first insulating layer 663 that is formed over the semiconductor layer 662.

As the nitrogen atmosphere, an atmosphere containing nitrogen (N) and rare gas (containing at least one of He, Ne, Ar, Kr, and Xe), an atmosphere containing nitrogen, hydrogen (H), and rare gas, or an atmosphere containing ammonium (NH₃) and rare gas can be used. As the oxygen atmosphere, an atmosphere containing oxygen (O) and rare gas, an atmosphere containing oxygen, hydrogen (H), and rare gas, or an atmosphere containing dinitrogen monoxide (N₂O) and rare gas can be used.

The gate electrode 664 can be made of an element selected from Ta, W, Ti, Mo, Al, Cu, Cr, and Nd, or an alloy or a compound containing a plurality of these elements. Furthermore, the gate electrode 664 may have a single layer structure or a stacked-layer structure made of these elements, or an alloy or a compound thereof In the drawings, the gate electrode 664 has a two-layer structure. Note that the gate electrode 664 and a wiring that is formed simultaneously with the gate electrode 664 are preferably led so that corners thereof are rounded when seen from the direction 3005 perpendicular to the top surface of the substrate 600. The gate electrode 664 and the wiring can be led in the same manner as that shown in FIG. 7B. The gate electrode 664 and the wiring that is formed simultaneously with the gate electrode 664 are shown as a wiring 3012 in the drawings. When corners 1202b of the wiring 3012 of the invention are rounded as compared to corners 1201b of the conventional wiring 3012, dusts and the like can be prevented from remaining at the corners of the wiring. As a result, defects of a semiconductor device caused by dusts can be reduced and the yield can be improved.

A thin film transistor is constituted by the semiconductor layer 662, the gate electrode 664, and the first insulating layer 663 functioning as a gate insulating film between the semiconductor layer 662 and the gate electrode 664. In this embodiment, the thin film transistor has a top gate structure; however, it may be a bottom gate transistor having a gate electrode under the semiconductor layer, or a dual gate transistor having gate electrodes over and under the semiconductor layer.

A second insulating layer 667 is desirably an insulating film such as a silicon nitride film, which has barrier properties to block ion impurities. The second insulating layer 667 is made of silicon nitride or silicon oxynitride. The second insulating layer 667 functions as a protective film to prevent contamination of the semiconductor layer 662. After depositing the second insulating layer 667, hydrogen gas may be introduced and the aforementioned high density plasma treatment may be applied, thereby hydrogenating the second insulating layer 667. Alternatively, the second insulating layer 667 may be nitrided and hydrogenated by introducing ammonium gas (NH₃). Otherwise, oxidization-nitridation treatment and hydrogenation treatment may be performed by introducing oxygen, dinitrogen monoxide (N₂O) gas, or the like together with hydrogen gas. By performing nitridation treatment, oxidization treatment, or oxidization-nitridation treatment in this manner, the surface of the second insulating layer 667 can be densified. As a result, the function of the second insulating layer 667 as a protective film can be enhanced. Hydrogen introduced into the second insulating layer 667 is discharged when thermal treatment is applied at a temperature of 400 to 450° C., thereby hydrogenating the semiconductor layer 662. Note that the hydrogenation treatment may be performed in combination with hydrogenation treatment using the first insulating layer 663.

A third insulating layer 665 can have a single layer structure or a stacked-layer structure of an inorganic insulating film or an organic insulating film. As the inorganic insulating film, a silicon oxide film formed by CVD, a silicon oxide film formed by SOG (Spin On Glass), or the like can be used. As the organic insulating film, a film made of polyimide, polyamide, BCB (benzocyclobutene), acrylic, a positive photosensitive organic resin, a negative photosensitive organic resin, or the like can be used.

The third insulating layer 665 may be made of a material having a skeleton structure formed of a bond of silicon (Si) and oxygen (O). An organic group containing at least hydrogen (such as an alkyl group and aromatic hydrocarbon) is used as a substituent of this material. Alternatively, a fluoro group may be used as the substituent Further alternatively, a fluoro group and an organic group containing at least hydrogen may be used as the substituent.

A wiring 666 can be made of one element selected from Al, Ni, W, Mo, Ti, Pt, Cu, Ta, Au, and Mn, or an alloy containing a plurality of these elements. Alternatively, a single layer structure or a stacked-layer structure made of these elements, an alloy or a compound thereof can be used. In the drawings, a single layer structure is shown as an example. Note that the wiring 666 is preferably led so that corners thereof are rounded when seen from the direction 3005 perpendicular to the top surface of the substrate 600. The wiring can be led in the same manner as that shown in FIG. 7B. The wiring 666 is shown as a wiring 3013 in the drawings. When corners 1202c of the wiring 3013 of the invention are rounded as compared to corners 1201c of the conventional wiring 3013, dusts and the like can be prevented from remaining at the corners of the wiring. As a result, defects of a semiconductor device caused by dusts can be reduced and the yield can be improved. In the structures shown in FIGS. 5A and 5C, the wiring 666 functions as a wiring connected to the source or the drain of the thin film transistor and also functions as the antenna 202. In the structures shown in FIGS. 5B and 5D, the wiring 666 functions as a wiring connected to the source or the drain of the thin film transistor and also functions as the terminal portion 602. FIGS. 7A and 7B each show a contact hole 3014 to connect the wiring 666 and the source or the drain of the thin film transistor.

The antenna 202 can also be formed by a droplet discharge method using a conductive paste containing nano-particles such as Au, Ag, and Cu. The droplet discharge method is a collective term for a method for forming a pattern by discharging droplets, such as an ink jet method and a dispenser method, which has advantages in that the utilization efficiency of a material is improved, and the like.

In the structures shown in FIGS. 5A and 5C, a fourth insulating layer 668 is formed over the wiring 666. The fourth insulating layer 668 can have a single layer structure or a stacked-layer structure of an inorganic insulating film or an organic insulating film. The fourth insulating layer 668 functions as a protective layer of the antenna 202.

Although the element group 601 formed over the substrate 600 (see FIG. 6A) may be used as it is, the element group 601 may be separated from the substrate 600 (see FIG. 6B) and attached to a flexible substrate 701 (see FIG. 6C). The flexible substrate 701 has flexibility, and a plastic substrate made of polycarbonate, polyarylate, polyether sulfone, or the like, a ceramic substrate, or the like can be used.

The element group 601 can be separated from the substrate 600 by (A) providing a separation layer between the substrate 600 and the element group 601 in advance and removing the separation layer using an etchant; (B) partially removing the separation layer using an etchant and physically separating the element group 601 from the substrate 600; or (C) mechanically removing the substrate 600 having high heat resistance over which the element group 601 is formed or removing the substrate 600 by etching with solution or gas. Noted that being physically separated means being separated by external stress, for example, stress applied by wind pressure blown from a nozzle, ultrasonic wave, or the like.

The aforementioned methods (A) and (B) are specifically realized by providing a metal oxide film between the substrate 600 having high heat resistance and the element group 601 and weakening the metal oxide film by crystallization to separate the element group 601, or by providing an amorphous silicon film containing hydrogen between the substrate 600 having high heat resistance and the element group 601 and removing the amorphous silicon film by laser light irradiation or etching to separate the element group 601.

The element group 601 that has been separated may be attached to the flexible substrate 701 using a commercialized adhesive, for example, an epoxy resin-based adhesive or a resin additive.

When the element group 601 is attached to the flexible substrate 701 over which an antenna is formed so that the element group 601 and the antenna are electrically connected, a semiconductor device that is thin, lightweight, and resistant to shock even when dropped is completed (see FIG. 6C). When the flexible substrate 701 that is inexpensive is used, an inexpensive semiconductor device can be provided. Moreover, since the flexible substrate 701 has flexibility, it can be attached to a curved surface or an irregular surface, and a variety of applications can be realized. For example, a wireless tag 720 as one mode of the semiconductor device of the invention can be tightly attached to a curved surface such as one of a medicine bottle (see FIG. 6D). In addition, when the substrate 600 is reused, a semiconductor device can be manufactured at low cost.

The element group 601 can be covered with a film to be sealed. The surface of the film may be coated with silicon dioxide (silica) powder. The coating allows the element group 601 to be kept waterproof in an environment of high temperature and high humidity. In other words, the element group 601 can have moisture resistance. Moreover, the surface of the film may have antistatic properties. The surface of the film may also be coated with a material containing carbon as a main component (such as diamond like carbon). The coating increases the intensity and can prevent the degradation or destruction of a semiconductor device. Alternatively, the film may be formed of a base material (for example, resin) mixed with silicon dioxide, a conductive material, or a material containing carbon as a main component. In addition, a surface active agent may be provided over the surface of the film, or directly added into the film, so that the element group 601 can have antistatic properties.

This embodiment can be freely combined with the aforementioned embodiment modes.

### Embodiment 2

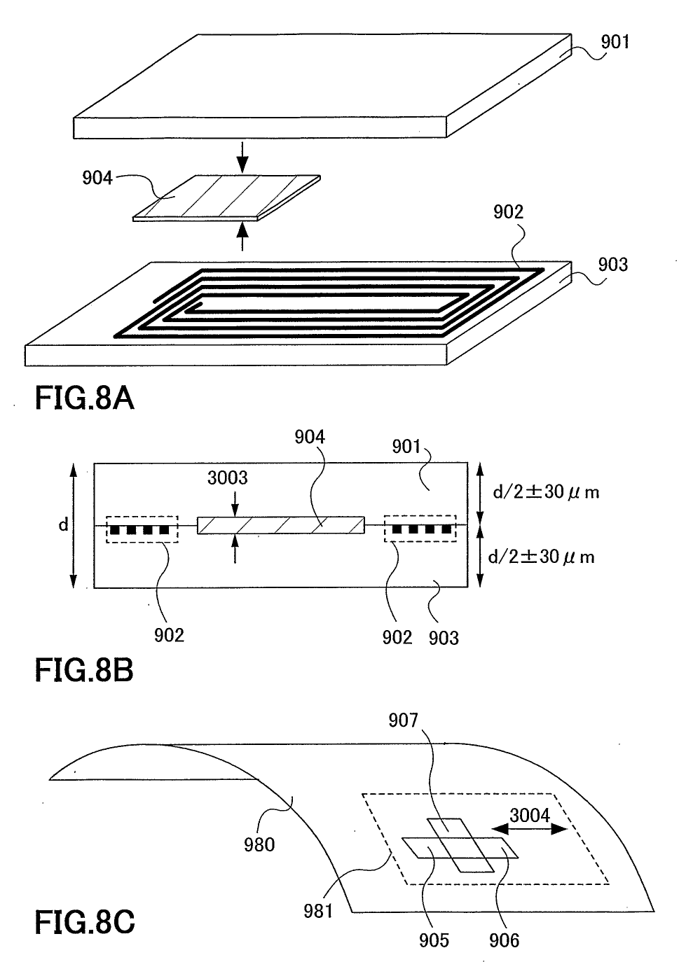

In this embodiment, an example where a semiconductor device of the invention has a flexible structure is described with reference to FIGS. 8A to 8C. In FIG. 8A, a semiconductor device of the invention includes a flexible protective layer 901, a flexible protective layer 903 including an antenna 902, and an element group 904 formed by a separation process and thinning of a substrate. The element group 904 can have a similar structure to the element group 601 described in Embodiment 1. The antenna 902 formed over the protective layer 903 is electrically connected to the element group 904. In FIG. 8A, the antenna 902 is formed only over the protective layer 903; however, the invention is not limited to this structure and the antenna 902 may be formed over the protective layer 901 as well. Note that a barrier film made of a silicon nitride film or the like may be formed between the element group 904 and each of the protective layer 901 and the protective layer 903. As a result, contamination of the element group 904 can be prevented, leading to a semiconductor device with improved reliability.

The antenna 902 can be formed of Ag, Cu, or metal plated with Ag or Cu. The element group 904 and the antenna 902 can be connected to each other using an anisotropic conductive film and applying ultraviolet treatment or ultrasonic wave treatment. Note that the element group 904 and the antenna 902 may be attached to each other using a conductive paste or the like.

By sandwiching the element group 904 between the protective layer 901 and the protective layer 903, a semiconductor device is completed (see arrows in FIG. 8A).

FIG. 8B shows a cross sectional structure of the thus formed semiconductor device. A thickness 3003 of the element group 904 which is sandwiched is 5 μm or less, and preferably 0.1 to 3 μm. Further, when the protective layer 901 and the protective layer 903 which overlap each other have a thickness of d, each of the protective layer 901 and the protective layer 903 preferably has a thickness of (d/2)±30 μm, and more preferably (d/2)±10 μm. In addition, each of the protective layer 901 and the protective layer 903 desirably has a thickness of 10 to 200 μm. The element group 904 has an area of 10 mm square (100 mm²) or smaller, and desirably 0.3 to 4 mm square (0.09 to 16 mm²).

The protective layer 901 and the protective layer 903 are made of an organic resin material, and thus have high resistance against bending. The element group 904 that is formed by a peeling process and thinning of a substrate also has higher resistance against bending as compared to a single crystal semiconductor. Since the element group 904, the protective layer 901, and the protective layer 903 can be tightly attached to each other without any space, a completed semiconductor device itself also has high resistance against bending. The element group 904 surrounded by the protective layer 901 and the protective layer 903 may be provided over a surface of or inside another object, or embedded in paper.

The case where a semiconductor device including the element group 904 is attached to a substrate having a curved surface is described with reference to FIG. 8C. FIG. 8C shows one transistor 981 selected from the element group 904. In the transistor 981, current flows from one 905 of a source and a drain to the other 906 of the source and the drain in accordance with a potential of a gate electrode 907. The transistor 981 is provided so that the direction of current flow in the transistor 981 (carrier movement direction 3004) and the direction of the arc of the substrate 980 cross at right angles. With such an arrangement, the transistor 981 is less affected by stress even when the substrate 980 is bent and draws an arc, and thus variations in characteristics of the transistor 981 included in the element group 904 can be suppressed.

This embodiment can be freely combined with the aforementioned embodiment modes and Embodiment 1.

### Embodiment 3

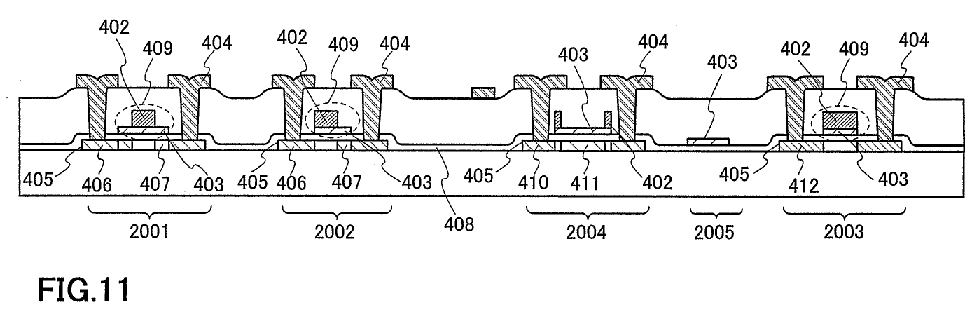

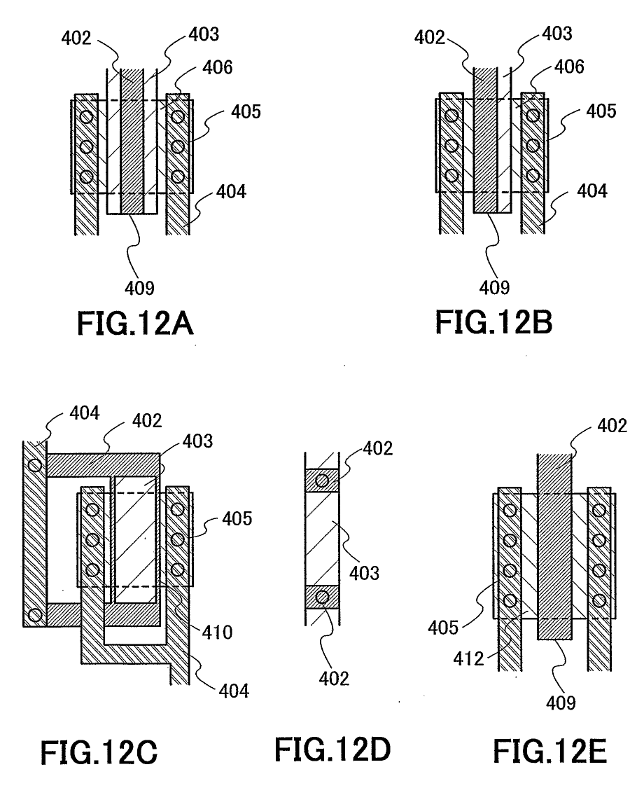

This embodiment shows a structure of a transistor used in a circuit that constitutes the semiconductor device 201 of the invention. The transistor may be a MOS transistor formed over a single crystalline substrate as well as a thin film transistor (TFT). FIG. 11 shows a cross sectional structure of such transistors used in a circuit. FIG. 11 shows an N-channel transistor 2001, an N-channel transistor 2002, a capacitor 2004, a resistor 2005, and a P-channel transistor 2003. Each of the transistors includes a semiconductor layer 405, an insulating layer 408, and a gate electrode 409. The gate electrode 409 has a stacked-layer structure of a first conductive layer 403 and a second conductive layer 402. FIGS. 12A to 12E are top views corresponding to the transistors, the capacitor, and the resistor shown in FIG. 11, and can also be referred to.

In FIG. 11, the N-channel transistor 2001 has the semiconductor layer 405 where a pair of impurity regions 407 are formed with a region overlapping the gate electrode 409 interposed therebetween so as to be arranged in the channel length direction (direction in which carriers flow). The impurity regions 407 are also called lightly doped drain (LDD) regions to which an impurity element imparting conductivity is added at a lower concentration than to impurity regions 406 forming a source region and a drain region that are in contact with wirings 404. In the case of forming the N-channel transistor 2001, the impurity regions 406 and the impurity regions 407 are added with an impurity imparting N-type conductivity, such as phosphorus. The LDD regions are formed to suppress hot electron degradation and short channel effects.

As shown in FIG. 12A, in the gate electrode 409 of the N-channel transistor 2001, the first conductive layer 403 is provided on both sides of the second conductive layer 402. In this case, the thickness of the first conductive layer 403 is smaller than that of the second conductive layer 402. The first conductive layer 403 is formed to have such a thickness that ion species accelerated with an electric field of 10 to 100 kV can pass through. The impurity regions 407 are formed to overlap the. first conductive layer 403 of the gate electrode 409. In other words, the LDD regions overlapping the gate electrode 409 are provided. In this structure, the impurity regions 407 are formed in a self-alignment manner by adding an impurity of one conductivity type to the gate electrode 409 through the first conductive layer 403 using the second conductive layer 402 as a mask. That is to say, the LDD regions overlapping the gate electrode are formed in a self-alignment manner.

A transistor having LDD regions on both sides of a gate electrode is applied to a rectifying transistor used in the first rectification circuit 223 and the second rectification circuit 225 in the power supply circuit 204 shown in FIG. 3, or a transistor constituting a transmission gate (also called an analog switch) used in a logic circuit. Such a transistor preferably includes LDD regions on both sides of a gate electrode since positive and negative voltages are applied to source and drain electrodes.

In FIG. 11, the N-channel transistor 2002 has the semiconductor layer 405 where the impurity region 407 is formed on one side of the channel forming region. The impurity region 407 is a lightly doped drain (LDD) region to which an impurity element is added at a lower concentration than to the impurity region 406. As shown in FIG. 12B, in the gate electrode 409 of the N-channel transistor 2002, the first conductive layer 403 is provided on one side of the second conductive layer 402. In this case also, the LDD region can be formed in a self-alignment manner by adding an impurity of one conductivity type through the first conductive layer 403 using the second conductive layer 402 as a mask.

A transistor having an LDD region on one side of a gate electrode may be applied to a transistor where either a positive voltage or a negative voltage is applied between source and drain electrodes. Specifically, the transistor having an LDD region on one side of the gate electrode may be applied to a transistor constituting a logic gate such as an inverter circuit, a NAND circuit, a NOR circuit, and a latch circuit, or a transistor constituting an analog circuit such as a sense amplifier, a constant voltage generation circuit, and a VCO (Voltage Controlled Oscillator).

In FIG. 11, the capacitor 2004 has a structure where the insulating layer 408 is sandwiched between the first conductive layer 403 and the semiconductor layer 405. The semiconductor layer 405 of the capacitor 2004 includes an impurity region 410 and an impurity region 411. The impurity region 411 is formed in the semiconductor layer 405 so as to overlap the first conductive layer 403. The impurity region 410 is in contact with the wiring 404. Since an impurity of one conductivity type can be added to the impurity region 411 through the first conductive layer 403, the impurity region 410 and the impurity region 411 may contain the same concentration of impurity or different concentrations of impurity. In any case, the semiconductor layer 405 of the capacitor 2004 functions as an electrode; therefore, it is preferable that an impurity of one conductivity type be added to the semiconductor layer 405 to reduce the resistance thereof. The first conductive layer 403 and the second conductive layer 402 can effectively function as an electrode of the capacitor 2004 by utilizing the second conductive layer 402 as an auxiliary electrode as shown in FIG. 12C. Such a composite electrode structure combining the first conductive layer 403 and the second conductive layer 402 allows the capacitor 2004 to be formed in a self-alignment manner.

The capacitor 2004 can be used as the storage capacitor 224 of the power supply circuit 204, the resonant capacitor 220 of the high frequency circuit 203, and the first capacitor 230 and the second capacitor 231 of the data demodulation circuit, which are shown in FIG. 3. In particular, the resonant capacitor is required to operate as a capacitor regardless of a positive or negative voltage applied between two terminals of the capacitor, since both positive and negative voltages are applied between the two terminals.

In FIG. 11, the resistor 2005 includes the first conductive layer 403 (see also FIG. 12D). The first conductive layer 403 is formed to have a thickness of about 30 to 150 nm; therefore, the resistor can be formed by appropriately setting the width and length thereof.

The resistor can be used as the resistance load of the data modulation circuit 208 shown in FIG. 1, as well as the first resistor 228 and the second resistor 229 of the data demodulation circuit 207 shown in FIG. 3. Further, the resistor can be used as the load in the case of controlling current by a VCO or the like. The resistor may be constituted by a semiconductor layer containing a high concentration of impurity element that imparts conductivity, or a thin metal layer. The metal layer is preferably used since the resistance thereof is determined by the film thickness and film quality and has few variations, though the resistance of the semiconductor layer depends on the film thickness, film quality, impurity concentration, activation rate, and the like.

In FIG. 11, the P-channel transistor 2003 includes the semiconductor layer 405 provided with impurity regions 412. The impurity regions 412 function as source and drain regions that are in contact with the wiring 404. The gate electrode 409 has a structure where the first conductive layer 403 and the second conductive layer 402 overlap each other (see also FIG. 12E). The P-channel transistor 2003 is a transistor with a single drain structure where an LDD region is not provided. When the P-channel transistor 2003 is formed, an impurity that imparts P-type conductivity, such as boron, is added to the impurity region 412. On the other hand, when an impurity that imparts N-type conductivity, such as phosphorus, is added to the impurity region 412, an N-channel transistor with a single drain structure can be obtained.

One or both of the semiconductor layer 405 and the gate insulating layer 408 may be oxidized or nitrided by high density plasma treatment. This treatment can be performed in a similar manner to that described in Embodiment 1.

According to the aforementioned treatment, the defect level in the interface between the semiconductor layer 405 and the gate insulating layer 408 can be reduced. When this treatment is applied to the gate insulating layer 408, the gate insulating layer 408 can be densified. In other words, generation of charged defects can be suppressed, and variations in threshold voltage of the transistor can be suppressed. When the transistor is driven with a voltage of 3 V or lower, an insulating layer that is oxidized or nitrided by the plasma treatment can be used as the gate insulating layer 408. If the driving voltage of the transistor is 3 V or higher, the gate insulating layer 408 can be formed by combining an insulating layer formed over the surface of the semiconductor layer 405 by the plasma treatment and an insulating layer deposited by CVD (plasma CVD or thermal CVD). In addition, the insulating layer may also be used as a derivative layer of the capacitor 2004. In this case, the insulating layer formed by the plasma treatment is a dense film with a thickness of 1 to 10 nm; therefore, a capacitor with large charge capacity can be obtained.

As described with reference to FIG. 11 and FIGS. 12A to 12E, the elements with various structures can be formed by combining conductive layers with different thicknesses. A region where only the first conductive layer is formed and a region where the first conductive layer and the second conductive layer are stacked can be formed using a photomask or a reticle provided with a diffraction grating pattern or a semi-transparent assist pattern for reducing light transmittance. That is to say, the amount of light passing through a photomask is controlled when the photoresist is exposed to light in a photolithography step, so that developed resist masks have different thicknesses. In that case, the resist with a complicated shape may be formed by providing the photomask or the reticle with slits that are apart with a distance of resolution limit or less. Further, the mask pattern made of a photoresist material may be deformed by baking at a temperature of about 200° C. after the development.

In addition, the region where only the first conductive layer is formed and the region where the first conductive layer and the second conductive layer are stacked can be continuously formed using a photomask or a reticle provided with a diffraction grating pattern or a semi-transparent assist pattern for reducing light transmittance. As shown in FIG. 12A, the region where only the first conductive layer is formed can be selectively formed over the semiconductor layer. Such a region where only the first conductive layer is formed over the semiconductor layer is advantageous since an LDD region can be manufactured in a self-alignment manner, though the region where only the first conductive layer is formed is not necessary in other regions (wiring regions connected to the gate electrode). When the photomask or the reticle is used, the region where only the first conductive layer is formed is not provided in the wiring regions, which substantially increases the wiring density.

In the case of FIG. 11 and FIGS. 12A to 12E, the first conductive layer is formed to have a thickness of 30 to 50 nm using a high melting point metal such as tungsten (W), chromium (Cr), tantalum (Ta), tantalum nitride (TaN), and molybdenum (Mo), or an alloy or a compound containing the high melting point metal as a main component. In addition, the second conductive layer is formed to have a thickness of 300 to 600 nm using a high melting point metal such as tungsten (W), chromium (Cr), tantalum (Ta), tantalum nitride (TaN), and molybdenum (Mo), or an alloy or a compound containing the high melting point metal as a main component. For example, the first conductive layer and the second conductive layer are made of different conductive materials so as to have a difference in etching rate in the subsequent etching step. The first conductive layer and the second conductive layer may be made of, for example, TaN and tungsten respectively.

Shown in this embodiment is the method where the transistor, the capacitor, and the resistor each having a different electrode structure can be formed in an etching step using the same photomask or reticle provided with a diffraction grating pattern or a semi-transparent assist pattern for reducing light transmittance. According to this embodiment, elements having different structures in accordance with circuit characteristics can be simultaneously formed and integrated without increasing the number of steps.

This embodiment can be freely combined with the aforementioned embodiment modes and Embodiments 1 and 2.

### Embodiment 4

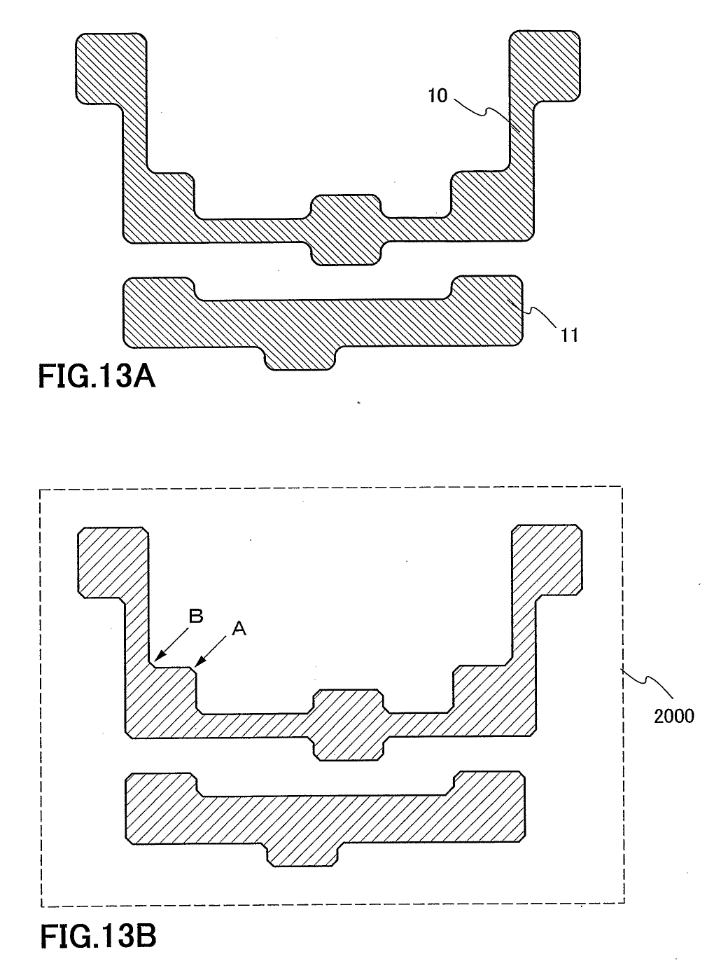

In this embodiment, an example of a static RAM (SRAM) that can be used as the memory circuit 210 and the like of the semiconductor device 201 is described with reference to FIGS. 13A to 15B.

A semiconductor layer 10 and a semiconductor layer 11 shown in FIG. 13A are preferably made of silicon or a crystalline semiconductor containing silicon. For example, the semiconductor layer 10 and the semiconductor layer 11 are made of polycrystalline silicon, single crystalline silicon, or the like that is obtained by crystallizing a silicon film by laser annealing. Further, a metal oxide semiconductor, amorphous silicon, or an organic semiconductor, which exhibits semiconductor characteristics, may also be employed.

In any case, a semiconductor layer formed first is provided over the entire surface or a part (region with a larger area than that determined as a semiconductor region of a transistor) of a substrate having an insulating surface. Then, a mask pattern is formed over the semiconductor layer by photolithography. The mask pattern is used for etching the semiconductor layer, thereby forming the semiconductor layer 10 and the semiconductor layer 11 having a specific island shape, which include a source region, a drain region, and a channel forming region of a transistor.

The photomask for forming the semiconductor layer 10 and the semiconductor layer 11 shown in FIG. 13A has a mask pattern 2000 shown in FIG. 13B. The mask pattern 2000 is different depending on whether a resist used in a photolithography step is a positive type or a negative type. In the case of using the positive type resist, the mask pattern 2000 shown in FIG. 13B is manufactured as a light shielding portion. The mask pattern 2000 has a shape in which a vertex portion A of a polygon is removed. The pattern of the photomask is chamfered, for example such that a right triangle with a side of 10 μm or shorter is removed in a corner. In addition, a corner portion B is bent so as not to be a right angle. When being enlarged, the corner portion B is bent in multiple degrees (see the structures described in Embodiment 1 with reference to FIGS. 7A and 7B).

The shape of the mask pattern 2000 shown in FIG. 13B is reflected in the semiconductor layer 10 and the semiconductor layer 11 shown in FIG. 13A. In that case, the shape similar to the mask pattern 2000 may be transferred, though the transfer may be conducted so that the corner of the mask pattern 2000 is further rounded. In other words, a round portion in which the pattern shape is smoother than the mask pattern 2000 may be provided.

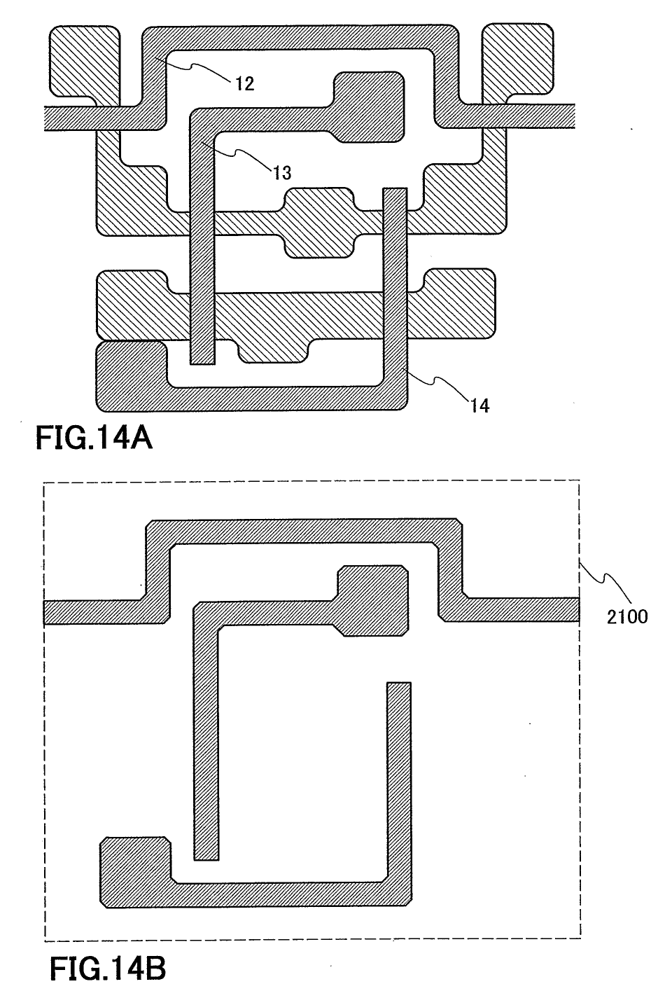

An insulating layer that contains silicon oxide or silicon nitride at least partially is formed over the semiconductor layer 10 and the semiconductor layer 11. One of the objects for forming this insulating layer is a gate insulating layer. Then, as shown in FIG. 14A, a gate wiring 12, a gate wiring 13, and a gate wiring 14 are formed so as to overlap the semiconductor layer partially. The gate wiring 12 is formed corresponding to the semiconductor layer 10, the gate wiring 13 is formed corresponding to the semiconductor layer 10 and the semiconductor layer 11, and the gate wiring 14 is formed corresponding to the semiconductor layer 10 and the semiconductor layer 11. In order to obtain the gate wirings, a metal layer or a semiconductor layer having high conductivity is deposited over the insulating layer and processed into a desired shape by photolithography.

The photomask for forming the gate wirings has a mask pattern 2100 shown in FIG. 14B. The mask pattern 2100 is chamfered such that a right triangle with a side of 10 μm or shorter, or half or less and fifth or more the line width of the wiring is removed in a corner. The shape of the mask pattern 2100 shown in FIG. 14B is reflected in the gate wiring 12, the gate wiring 13, and the gate wiring 14 shown in FIG. 14A. In that case, the shape similar to the mask pattern 2100 may be transferred, though the transfer may be conducted so that the corner of the mask pattern 2100 is further rounded. In other words, a round portion in which the pattern shape is smoother than the mask pattern 2100 may be provided. That is to say, each corner of the gate wiring 12, the gate wiring 13, and the gate wiring 14 may be rounded. Outside of the corner has an effect that the generation of fine powder due to abnormal discharge can be suppressed in dry etching using plasma. Inside of the corner has an effect that even if fine powder that easily gathers in the corner is generated in cleaning, it can be washed away. As a result, improvement in yield can be much expected.

An interlayer insulating layer is formed after the gate wiring 12, the gate wiring 13, and the gate wiring 14. The interlayer insulating layer is made of an inorganic insulating material such as silicon oxide, or an organic insulating material using polyimide, acrylic resin, or the like. An insulating layer made of silicon nitride, silicon nitride oxide, or the like may be formed between the interlayer insulating layer and the gate wiring 12, the gate wiring 13, and the gate wiring 14. In addition, an insulating layer made of silicon nitride, silicon nitride oxide, or the like may be formed over the interlayer insulating layer. Such an insulating layer can prevent the semiconductor layer and the gate insulating layer from being contaminated with impurities such as extrinsic metal ion and moisture, which may adversely affect a thin film transistor (TFT).

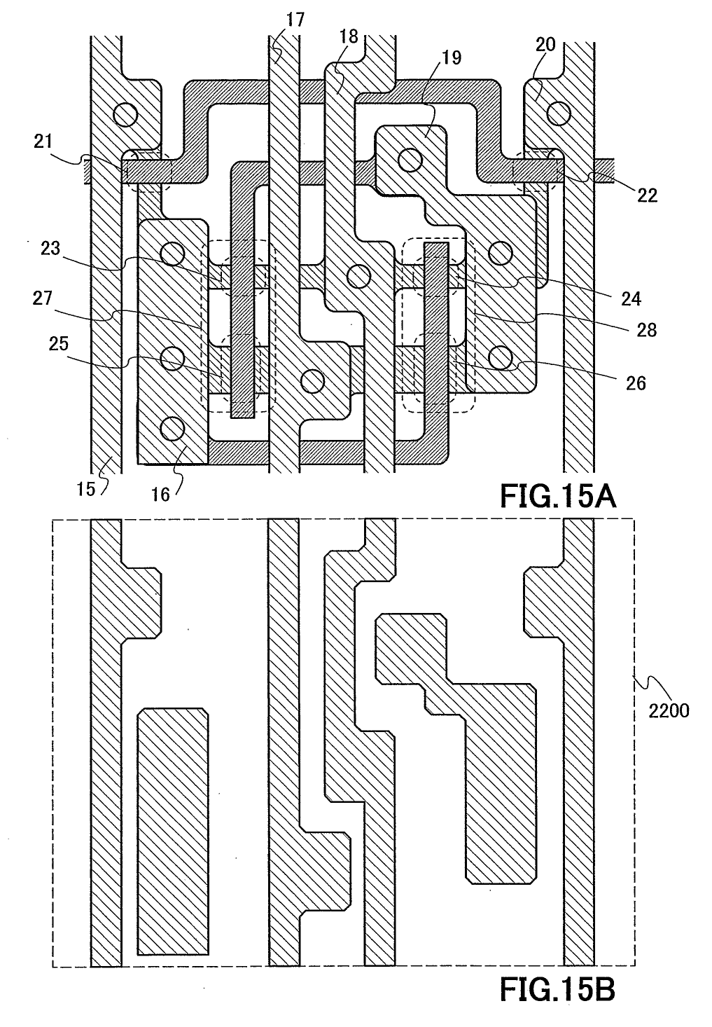

In the interlayer insulating layer, an opening is formed in a predetermined position. For example, the opening is provided corresponding to the gate wiring or semiconductor layer in the lower layer. A wiring layer including one layer or a plurality of layers made of metal or a metal compound is processed into a predetermined pattern by etching using a mask pattern that is formed by photolithography. Then, as shown in FIG. 15A, wirings 15 to 20 are formed so as to partially overlap the semiconductor layer 10 and the semiconductor layer 11. Each of the wirings connects particular elements. Each of the wirings connects particular elements not with a straight line but with a line including a corner portion due to layout limitations. In addition, a wiring width changes in a contact portion with other wirings or in other regions. The wiring width increases in a contact portion if the size of a contact hole is equal to or larger than the wiring width.

A photomask for forming the wires 15 to 20 has a mask pattern 2200 shown in FIG. 15B. In that case also, the mask pattern is chamfered such that a right triangle with a side of 10 μm or shorter, or half or less and fifth or more the line width of the wiring is removed in a corner. Further, the corner may be rounded. Outside of such a wiring has an effect that the generation of fine powder due to abnormal discharge can be suppressed in dry etching using plasma. Inside of the wiring has an effect that even if fine powder that easily gathers in the corner is generated in cleaning, it can be washed away. As a result, improvement in yield can be much expected. Further, the wiring with a rounded corner improves electrical conduction of wirings. In addition, the use of a wiring with a rounded corner in a structure including multiple parallel wirings is highly advantageous to wash way dusts.

FIG. 15A shows N-channel transistors 21 to 24 and P-channel transistors 25 and 26. An inverter 27 is constituted by the N-channel transistor 23 and the P-channel transistor 25. An inverter 28 is constituted by the N-channel transistor 24 and the P-channel transistor 26. An SRAM is constituted by a circuit including these six transistors. An insulating layer made of silicon nitride, silicon oxide, or the like may be formed over these transistors.

This embodiment can be freely combined with the aforementioned embodiment modes and Embodiments 1 to 3.

### Embodiment 5

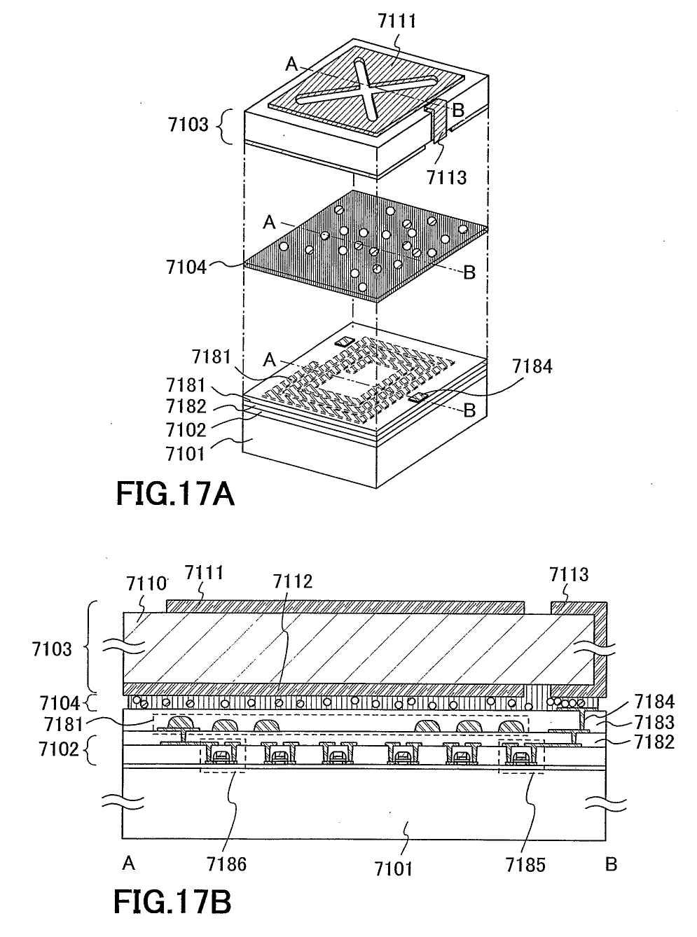

One embodiment of the semiconductor device 201 of the invention is shown in FIGS. 17A and 17B. FIG. 17A is a development view of the semiconductor device 201, and FIG. 17B is a cross sectional view along a line A-B of FIG. 17A. Described in this embodiment is a structure of the semiconductor device 201 including a plurality of antennas, particularly the semiconductor device 201 including an antenna and a patch antenna that are formed over a layer having a thin film transistor.

Similarly to the method for manufacturing the element group 601 described in Embodiment 1, a layer 7102 including thin film transistors is formed over an insulating substrate 7101. An interlayer insulating layer 7182 is formed over the layer 7102 including thin film transistors. A first antenna 7181 is formed over the interlayer insulating layer 7182. An insulating layer 7183 is formed over the first antenna 7181, and a connecting terminal 7184 is formed on the surface of the insulating layer 7183.

The insulating layer 7183, in a part of which the connecting terminal 7184 is exposed, is attached to a patch antenna 7103 that is a second antenna with an anisotropic conductive adhesive 7104. The connecting terminal 7184 is electrically connected to a power feeding layer 7113 of the patch antenna with conductive particles dispersed in the anisotropic conductive adhesive 7104. The connecting terminal 7184 is also electrically connected to a first thin film transistor 7185 that is formed in the layer 7102 including thin film transistors. Further, the first antenna 7181 is electrically connected to a second thin film transistor 7186 that is formed in the layer 7102 including thin film transistors. Note that a conductive layer that is obtained by curing a conductive paste may be used instead of the anisotropic conductive adhesive.

The first antenna 7181 is made of a metal material containing aluminum, copper, or silver. For example, composition of copper or silver paste can be formed by a printing method such as screen printing, offset printing, and ink-jet printing. Alternatively, an aluminum film may be formed by sputtering or the like and processed by etching. The first antenna 7181 may also be formed by electrolytic plating or electroless plating.

Note that the first antenna 7181 can be omitted.

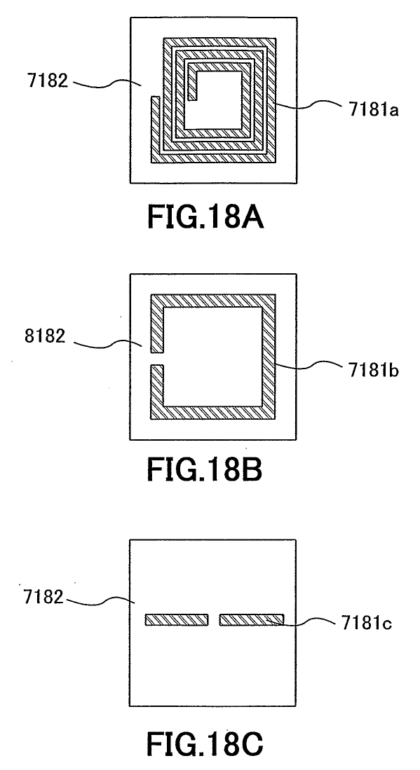

Here, the first antenna 7181 has a shape of a square coil as shown in FIG. 18A.

The shape of the first antenna 7181 is described with reference to FIGS. 18A to 18C. FIGS. 18A to 18C are top views showing the interlayer insulating layer 7182 and an antenna formed thereover. Although the first antenna 7181 has a square coil shape 7181a as shown in FIG. 17A and FIG. 18A in this embodiment, the shape is not limited to this. The antenna may have a circular coil shape. Alternatively, as shown in FIG. 18B, the antenna may have a square loop shape 7181b. The antenna may also have a circular loop shape. Furthermore, as shown in FIG. 18C, the antenna may have a linear-dipole shape 7181c. Moreover, the antenna may also have a curved-dipole shape.

By thus providing a plurality of antennas, a multiband semiconductor device that is capable of receiving electric waves with different frequencies can be formed.

This embodiment can be freely combined with the aforementioned embodiment modes and Embodiments 1 to 4.

### Embodiment 6

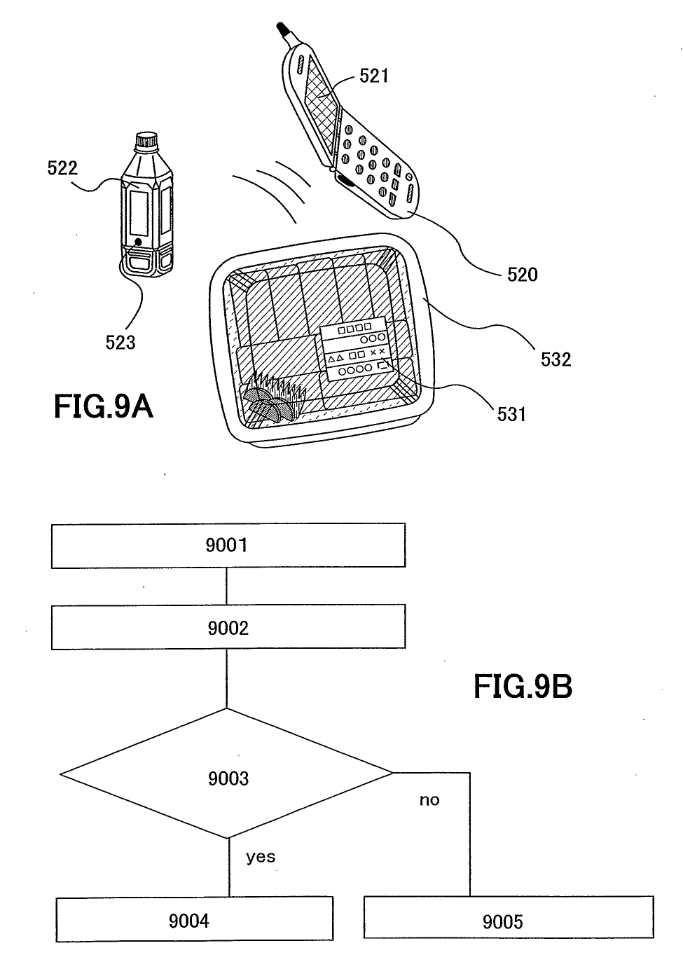

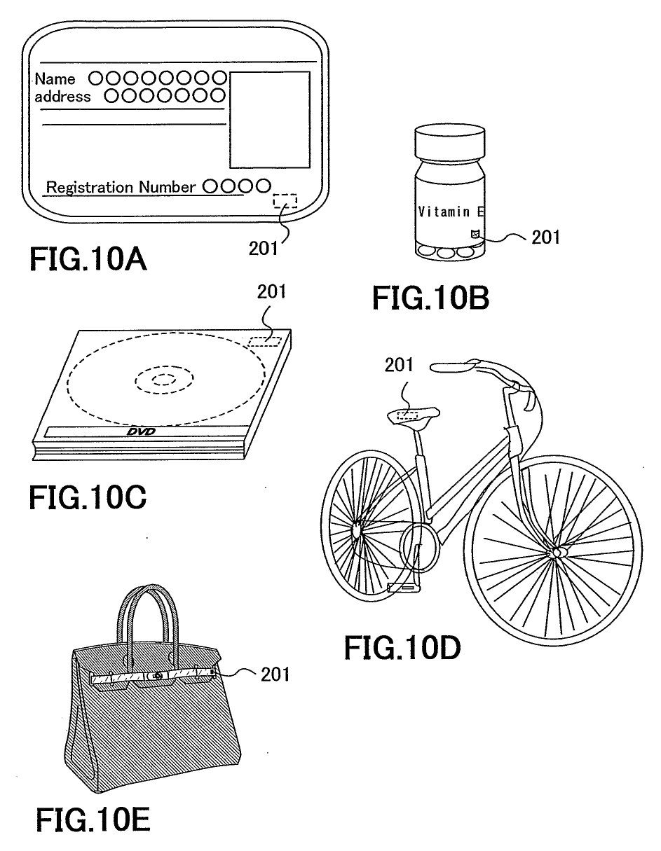

In this embodiment, applications of the semiconductor device 201 of the invention are described with reference to FIGS. 9A to 10E. The semiconductor device 201 can be incorporated in, for example, bills, coins, securities, bearer bonds, certificates (driving license, resident card, and the like, see FIG. 10A), containers for wrapping objects (wrapping paper, bottle, and the like, see FIG. 10B), recording media such as DVDs, CDs, and video tapes (see FIG. 10C), vehicles such as cars, motorbikes, and bicycles (see FIG. 10D), personal belongings such as bags and glasses (see FIG. 10E), foods, clothes, commodities, electronic apparatuses, and the like. The electronic apparatuses include a liquid crystal display device, an EL (electroluminescence) display device, a television set (also simply called a television or a television receiver), a mobile phone set, and the like.

The semiconductor device 201 can be fixed to an object by being attached to the surface of the object or embedded in the object. For example, the semiconductor device 201 may be embedded in paper of a book, or organic resin of a package. When the semiconductor device 201 is incorporated in bills, coins, securities, bearer bonds, certificates, and the like, forgery thereof can be prevented. Further, when semiconductor device 201 is incorporated in. containers for wrapping objects, recording media, personal belongings, foods, clothes, commodities, electronic apparatuses, and the like, inspection system, rental system, and the like can be performed more efficiently. The semiconductor device 201 can also prevent vehicles from being forged or stolen. In addition, when the semiconductor device 201 is implanted into creatures such as animals, each creature can be identified easily. For example, when the semiconductor device 201 is implanted into creatures such as domestic animals, the year of birth, sex, breed, and the like thereof can be identified easily.

As set forth above, the semiconductor device 201 of the invention can be incorporated in any object (including creatures).

The semiconductor device 201 has various advantages such that data can be transmitted and received through wireless communication, the semiconductor device can be processed into various shapes, and wide directivity and recognition range are achieved depending on a selected frequency.

Next, one mode of a system using the semiconductor device 201 is described with reference to FIGS. 9A and 9B. A reader/writer 520 is provided on a side of a portable terminal including a display portion 521, a semiconductor device 523 of the invention is provided on a side of an object A 522, and a semiconductor device 531 of the invention is provided on a side of an object B 532 (see FIG. 9A). When the reader/writer 520 is brought close to the semiconductor device 523 included in the object A 522, information on the object A 522, such as ingredients, place of origin, test result in each production step, history of the distribution process, and explanation of the object is displayed on the display portion 521. When the reader/writer 520 is brought close to the semiconductor device 531 included in the object B 532, information on the object B 532, such as ingredients, place of origin, test result in each production step, history of the distribution process, and explanation of the object is displayed on the display portion 521.

An example of a business model utilizing the system shown in FIG. 9A is described with reference to a flow chart shown in FIG. 9B. Information on food allergy is inputted to a portable terminal (9001:step 1). The information on food allergy is information on ingredients and the like that may cause allergic reactions to certain people. As described above, the information on the object A 522 is obtained by the reader/writer 520 incorporated in the portable terminal (9002:step 2). Here, the object A 522 is food. The information on the object A 522 includes information on the ingredients of the object A 522. The information on food allergy is compared to the obtained information on the object A 522, thereby determining whether corresponding ingredients are contained (9003:step 3). If the corresponding ingredients are contained, the user of the portable terminal is alerted that certain people may have allergic reactions to the object A (9004:step 4). If the corresponding ingredients are not contained, the user of the portable terminal is informed of that certain people are at low risk of having allergic reactions to the object A (the fact that the object A is safe) (9005:step 5). In the step 4 and the step 5, the information may be displayed on the display portion 521 of the portable terminal, or an alarm of the portable terminal or the like may be used to inform the user of the portable terminal of the information.

Since the semiconductor device 201 of the invention prevents an excess voltage, high reliability and reduced size can be achieved. Therefore, according to the invention, the application range of the semiconductor device 201 increases, and various systems can be realized. As a result, a system with high performance and high added value can be provided.

This embodiment can be freely combined with the aforementioned embodiment modes and Embodiments 1 to 5.

This application is based on Japanese Patent Application serial No. 2005-185638 filed in Japan Patent Office on Jun. 24 in 2005, the entire contents of which are hereby incorporated by reference.

### EXPLANATION OF REFERENCE

10: semiconductor layer 11: semiconductor layer 12: gate wiring 13: gate wiring 14: gate wiring 15: wiring 16: wiring 17: wiring 18: wiring 19: wiring 20: wiring 21: transistor 22: transistor 23: transistor 24: transistor 25: transistor 26: transistor 27: inverter 28: inverter 101: analog circuit portion 102: digital circuit portion (logic circuit portion) 201: semiconductor device 202: antenna 203: high frequency circuit 204: power supply circuit 205: reset circuit 206: clock generation circuit 207: data demodulation circuit 208: data modulation circuit 209: control circuit 210: memory circuit 211: semiconductor integrated circuit 220: resonant capacitor 221: first band-path filter 222: second band-pass filter 223: first rectification circuit 224: storage capacitor 225: second rectification circuit 226: circuit in control circuit 227: inverter 228: first resistor 229: second resistor 230: first capacitor 231: second capacitor 232: N-channel transistor 233: N-channel transistor 234: N-channel transistor 235: N-channel transistor 301: semiconductor device 302: antenna 303: high frequency circuit 304a: power supply circuit 304b: limiter circuit 304c: reset circuit 304d: clock generation circuit 305: data demodulation circuit 306: data modulation circuit 307: control circuit 308: memory circuit 309: semiconductor integrated circuit 402: second conductive layer 403: first conductive layer 404: wiring 405: semiconductor layer 406: impurity region 407: impurity region 408: insulating layer 409: gate electrode 410: impurity region 411: impurity region 412: impurity region 520: reader/writer 521: display portion 522: object A 523: semiconductor device 531: semiconductor device 532: object B 600: substrate 601: element group 602: terminal portion 603: conductive particle 604: resin 610: substrate 661: base layer 662: semiconductor layer 662a: channel forming region 662b: impurity region 662c: low concentration impurity region 663: first insulating layer 664: gate electrode 665: third insulating layer 666: wiring 667: second insulating layer 668: fourth insulating layer 701: flexible substrate 720: wireless tag 901: protective layer 902: antenna 903: protective layer 904: element group 905: one of a source and a drain 906: the other of the source and the drain 907: gate electrode 980: substrate 981: transistor 1101: analog circuit portion 1102: digital circuit portion (logic circuit portion) 1201a: corner 1201b: corner 1201c: corner 1202a: corner 1202b: corner 1202c: corner 2000: mask pattern 2100: mask pattern 2200: mask pattern 2001: transistor 2002: transistor 2003: transistor 2004: capacitor 2005: resistor 3003: thickness 3004: carrier movement direction 3005: direction 3011: wiring 3012: wiring 3013: wiring 3014: contact hole 5000a: terminal 5000b: terminal 5001a: N-type semiconductor layer 5001b: P-type semiconductor layer 5002: contact hole 5003: first wiring 5004: second wiring 5501: P-channel transistor 5502: N-channel transistor 5550: N-channel transistor 7101: insulating substrate 7102: layer 7103: patch antenna 7104: anisotropic conductive adhesive 7113: power feeding layer 7181: first antenna 7181a: square coil shape 7181b: square loop shape 7181c: linear-dipole shape 7182: interlayer insulating layer 7183: insulating layer 7184: connecting terminal 7185: first thin film transistor 7186: second thin film transistor

1. A semiconductor device communicating data through wireless communication, comprising:
an analog circuit portion to which a wireless signal is inputted; and
a digital circuit portion to which an output signal from the analog circuit portion is inputted,
wherein a gate length of a transistor included in the analog circuit portion is not less than a gate length of a transistor included in the digital circuit portion.

2. A semiconductor device communicating data through wireless communication, comprising:
an analog circuit portion to which a wireless signal is inputted; and
a digital circuit portion to which an output signal from the analog circuit portion is inputted,
wherein the analog circuit portion comprises a power supply circuit for generating a DC voltage using the wireless signal, and a data demodulation circuit for demodulating the wireless signal; and
wherein a gate length of a transistor included in each of the power supply circuit and the data demodulation circuit is not less than a gate length of a transistor included in the digital circuit portion.

3. A semiconductor device communicating data through wireless communication, comprising:
an analog circuit portion to which a wireless signal is inputted; and
a digital circuit portion to which an output signal from the analog circuit portion is inputted,
wherein the analog circuit portion comprises a power supply circuit for generating a DC voltage using the wireless signal, and a data demodulation circuit for demodulating the wireless signal; and
wherein among transistors included in the power supply circuit and the data demodulation circuit, a gate length of each of a transistor connected to an input of the power supply circuit and a transistor connected to an input of the data demodulation circuit is not less than a gate length of a transistor included in the digital circuit portion.

4. A semiconductor device communicating data through wireless communication, comprising:
an analog circuit portion to which a wireless signal is inputted,
wherein the analog circuit portion comprises a power supply circuit for generating a DC voltage using the wireless signal, a data demodulation circuit for demodulating the wireless signal, and a clock generation circuit for generating a clock using an output of the data demodulation circuit; and
wherein a gate length of a transistor included in each of the power supply circuit and the data demodulation circuit is not less than a gate length of a transistor included in the clock generation circuit.

5. A semiconductor device communicating data through wireless communication, comprising:
an analog circuit portion to which a wireless signal is inputted,
wherein the analog circuit portion comprises a power supply circuit for generating a DC voltage using the wireless signal, a data demodulation circuit for demodulating the wireless signal, and a clock generation circuit for generating a clock using an output of the data demodulation circuit; and
wherein among transistors included in the power supply circuit and the data demodulation circuit, a gate length of each of a transistor connected to an input of the power supply circuit and a transistor connected to an input of the data demodulation circuit is not less than a gate length of a transistor included in the clock generation circuit.

6. A semiconductor device communicating data through wireless communication, comprising:
an analog circuit portion to which a wireless signal is inputted; and
a digital circuit portion to which an output signal from the analog circuit portion is inputted,
wherein a gate length of a transistor included in the analog circuit portion is not less than twice a gate length of a transistor included in the digital circuit portion.

7. A semiconductor device communicating data through wireless communication, comprising:
an analog circuit portion to which a wireless signal is inputted; and
a digital circuit portion to which an output signal from the analog circuit portion is inputted,
wherein the analog circuit portion comprises a power supply circuit for generating a DC voltage using the wireless signal, and a data demodulation circuit for demodulating the wireless signal; and
wherein a gate length of a transistor included in each of the power supply circuit and the data demodulation circuit is not less than twice a gate length of a transistor included in the digital circuit portion.

8. A semiconductor device communicating data through wireless communication, comprising:
an analog circuit portion to which a wireless signal is inputted; and
a digital circuit portion to which an output signal from the analog circuit portion is inputted,
wherein the analog circuit portion comprises a power supply circuit for generating a DC voltage using the wireless signal, and a data demodulation circuit for demodulating the wireless signal; and
wherein among transistors included in the power supply circuit and the data demodulation circuit, a gate length of each of a transistor connected to an input of the power supply circuit and a transistor connected to an input of the data demodulation circuit is not less than twice a gate length of a transistor included in the digital circuit portion.

9. A semiconductor device communicating data through wireless communication, comprising:
an analog circuit portion to which a wireless signal is inputted,
wherein the analog circuit portion comprises a power supply circuit for generating a DC voltage using the wireless signal, a data demodulation circuit for demodulating the wireless signal, and a clock generation circuit for generating a clock using an output of the data demodulation circuit; and
wherein a gate length of a transistor included in each of the power supply circuit and the data demodulation circuit is not less than twice a gate length of a transistor included in the clock generation circuit.

10. A semiconductor device communicating data through wireless communication, comprising:
an analog circuit portion to which a wireless signal is inputted,
wherein the analog circuit portion comprises a power supply circuit for generating a DC voltage using the wireless signal, a data demodulation circuit for demodulating the wireless signal, and a clock generation circuit for generating a clock using an output of the data demodulation circuit; and
wherein among transistors included in the power supply circuit and the data demodulation circuit, a gate length of each of a transistor connected to an input of the power supply circuit and a transistor connected to an input of the data demodulation circuit is not less than twice a gate length of a transistor included in the clock generation circuit.

11. The semiconductor device according to any one of claims 1 to 3 and 6 to 8, wherein the digital circuit portion comprises a memory portion.

12. The semiconductor device according to any one of claims 1 to 3 and 6 to 8, wherein a power supply voltage of the analog circuit portion is equal to a power supply voltage of the digital circuit portion.

13. A wireless communication system comprising:
the semiconductor device according to any one of claims 1 to 10; and
a reader/writer communicating data with the semiconductor device through wireless communication.

14. A semiconductor device communicating data through wireless communication, comprising:
an analog circuit portion to which a wireless signal is inputted; and
a digital circuit portion to which an output signal from the analog circuit portion is inputted,
wherein the shortest length of different gate lengths of a transistor included in the analog circuit portion is not less than the longest length of different gate lengths of a transistor included in the digital circuit portion.
